(19) United States
(12) Patent Application Publication
(10) Pub. No.: US 2004/0193943 A1
(43) Pub. Date: Sep. 30, 2004

(54) Multiparameter network fault detection system using probabilistic and aggregation analysis

(76) Inventors: Robert Angelino, Corona, CA (US); Ursula Schwuttke, Dana Point, CA (US)

Correspondence Address: FISH & RICHARDSON, PC, 12390 EL CAMINO REAL, SAN DIEGO, CA, 92130-2081, US

(21) Appl. No.: 10/778,920

(22) Filed: Feb. 12, 2004

Related U.S. Application Data
(60) Provisional application No. 60/447,687, filed on Feb. 13, 2003.

(51) Int. Cl. H02H 3/05

(52) U.S. Cl. 714/4

(57) ABSTRACT

A network intrusion detection system using both probabilistic analysis and aggregation analysis. The system is run within a network system, and includes a first set of firewall rules, a second set of intrusion detection rules, and a third set of authentication rules which authenticates the user, the VPN, and host intrusion. A special correlation rule set correlates among the other rules in order to determine information from patterns. The rules look at probabilistic information and also look at patterns within the data, attempting to find where intrusions may exist prior to their actual occurance.

### CROSS-REFERENCE TO RELATED PATENT APPLICATION

This application claims priority from U.S. Provisional Patent Application No. 60/447,687, filed Feb. 13, 2003, the contents of which are incorporated by reference to the extent necessary for proper understanding of this document.

### BACKGROUND

Network intrusion detection typically relies on detecting certain known “signatures”, which indicate that an unauthorized user is attempting to access network resources. Network intrusion systems of this type typically fail when a new and/or unexpected type of network intrusion occurs. The network intrusions can be very costly in terms of time and resources, and large amounts of resources are often placed on avoiding these network intrusions. However, a false detection of an intrusion may be just as harmful as a lack of detection of a real intrusion. Therefore, it is important to maintain accuracy in the intrusion detection process.

Detection of network intrusions are typically done by looking for an anomaly according to a specified rule that describes contents of the anomaly. However, sometimes, the anomaly cannot be described by any conventional rule, either because the anomaly is unknown, or the anomaly is part of a new kind of network intrusion.

Another way of looking for network intrusions is to monitor all of the network information, and attempt to deduce the intrusion from that monitoring. However, this requires the monitoring of huge quantities of data; perhaps as much as Terabytes per day.

Once detected, faults can be displayed in many different ways. The assignee of this application, for example, may display faults using the techniques disclosed in U.S. Pat. No. 6,222,547.

### SUMMARY

The present disclosed system describes new ways of detecting intrusion events in systems, using special kinds of rules. One aspect involves determining network faults using the special techniques described herein.

Another technique describes using Bayesian analysis to look for patterns in data, and to detect unusual events. Probabilities are assigned to the events to reduce false positives. The unusual events are correlated, to determine a signature of an anomaly based on the unusual events themselves, rather than based on a rule.

Another technique uses rule sets, including a rule set for an entry point such as a firewall, a rule set for intrusion detection, and a rule set for authentication. One or more of these rule sets may use probabilistic techniques to detect faults or possible faults. A correlation rule set is used to gain intelligence from the combinations of different rules.

The rules described herein monitor firewalls, network intrusion detection, VPNs, and other applications.

### BRIEF DESCRIPTION OF THE DRAWINGS

These and other aspects will now be described in detail with reference to the accompanying drawings, wherein:

FIG. 1 shows a basic network system with its different components;

FIG. 2 shows the different rule sets and their interactions

FIG. 3 shows a diagram of the firewall rules;

FIG. 4 shows a diagram of the network intrusion rules;

FIG. 5 shows the network authentication rules which includes user authentication rules, VPN rules, and host intrusion rules;

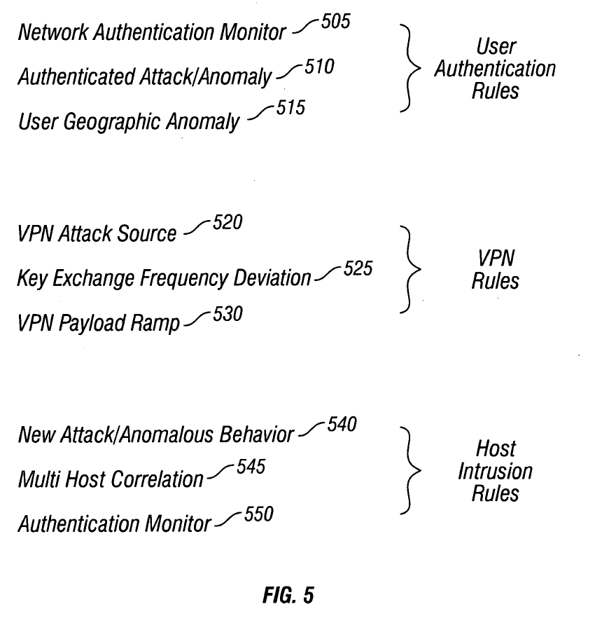

FIG. 6 illustrates the correlation rules.

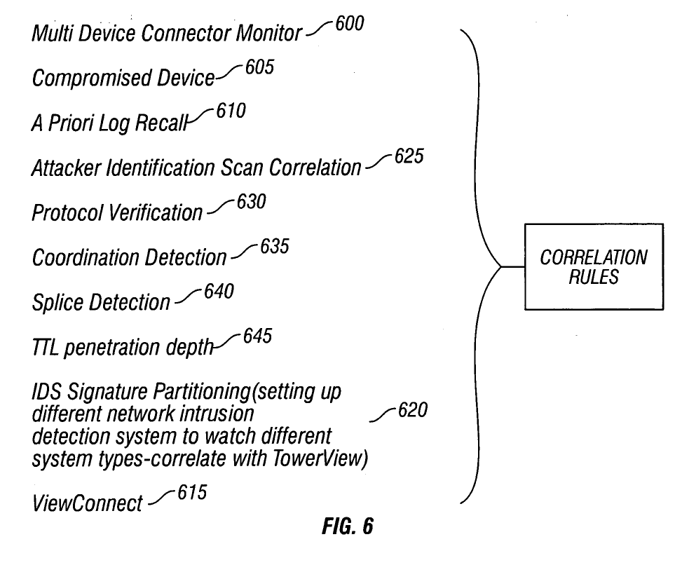

### DETAILED DESCRIPTION

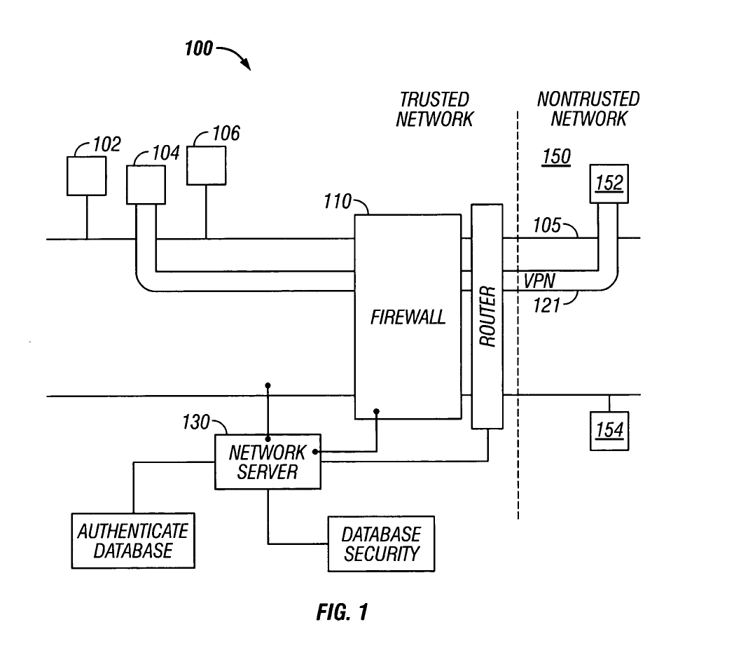

FIG. 1 shows the basic layout of one network using the present techniques. A trusted network 100 is the network being protected. A data pipe 105 connects the trusted network 100 to a non-trusted network 150, for example which may be a publicly accessible network such as the Internet.

The trusted network 100 is shown with a number of network clients 102, 104, 106 connected thereto. In general, however, the trusted network 100 may have any number of computers connected thereto. Similarly, the non trusted network, while shown with clients 152 and 154, is typically connected to many different computers of many different types.

The trusted network entry point is shown having a router 101, and a firewall 110. A router may monitor the addresses and provide a switching function for the incoming traffic. A firewall is a device that restricts network traffic at the border between the trusted network and the non trusted network. The firewall is typically a software program running within a gatekeeper of the trusted network, but can also be done in hardware or other more sophisticated ways. A sophisticated firewall may also include firewall switches and other hardware. The firewall can be configured to allow certain packets, and/or denying other packets, or to prevent all access, when necessary.

Firewalls typically restrict the network traffic as it flows between the trusted network 100 and non-trusted network 150. Each data packet may be evaluated by the firewall using rules that are intended for detecting improper actions of various sorts, known as the firewall rules set. The packet may be accepted or rejected based on characteristics of the rule set.

A key concept of the present system is the concept of “intrusion events”. An intrusion event is an event that is detected by the monitoring software and hardware systems. These represent things that happen on a system either representing an actual attempt at intrusion, or some action which may signify a failed attempt at intrusion or a future attempt at intrusion.

Authentication determines whether the user is a user with proper access to the resources. The authentication protocols may include many sophisticated and special-purpose connections.

One such special-purpose connection is a virtual Private network, shown as 121 which is basically a pipe from the non-trusted network to the trusted network. Other features of the connection may include Dynamic Host Configuration Protocol (DHCP) services, network attack detection/countermeasures and Virtual Private Network services.

The present application describes special rule sets, probabilistic aspects of those rule sets, and correlations between the rule sets. These rule sets monitor trends within the data acquisition, to determine situations that are likely precursors to a full on intrusion event.

One aspect of the probabilistic aspect defines using Bayesian analysis as a part of the detection process. Bayesian analysis is a statistical procedure which estimates parameters of an underlying distribution based on the observed part of the distribution. In many ways, Bayesian analysis is just a guess, since its assessment of probability depends on the validity of the prior distribution, and can not be assessed statistically.

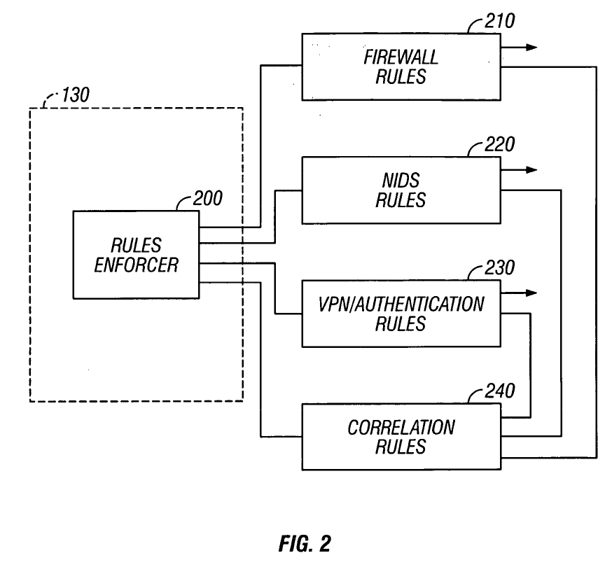

FIG. 2 shows the relation between the different rule sets. An administrative console, here the network server 130, runs a rules enforcer module 200 which administers the different rule sets. The different sets of rules includes the firewall rules 210, the network intrusion detection system rules 220, and the VPN and authentication rules 230. Each of these rule sets include special rules which are intended to find faults. A correlation rules set 240 correlates among the different rules noted above, to create output based on correlations between these different rules.

### Firewall Rules

The firewall rules are used to determine intrusion events based on actions within the firewall 110.

The firewall is administered by a firewall administrator, who has unrestricted access to the network resources and firewall, typically via the network server 130. The administrator creates a firewall rule set that allows or restricts network traffic from flowing between trusted and non-trusted networks typically based on packet protocol and IP address of the packet. The administrator also configures the firewall's special features, performs routine maintenance of the rule-set as host IP addresses and application protocols change, maintains the firewall software/logic by applying patches and updates, and periodically reviews the firewall logs.

In the embodiment, the Firewall can be configured to send performance and operational messages to a server, which can be the server 130, or a remote logging or management server. The information contained in the messages can be used to monitor the configuration and operation of the firewall. These messages can also be used to generate statistics and trend information as described herein, to assist the firewall administrator in spotting long term attacks, configuration issues and provisioning problems. The firewall messages may communicate information about what rules have been executed, what special features have been invoked, administrative information, as well as the condition of the hardware and software coming e.g. hardware and software status and faults.

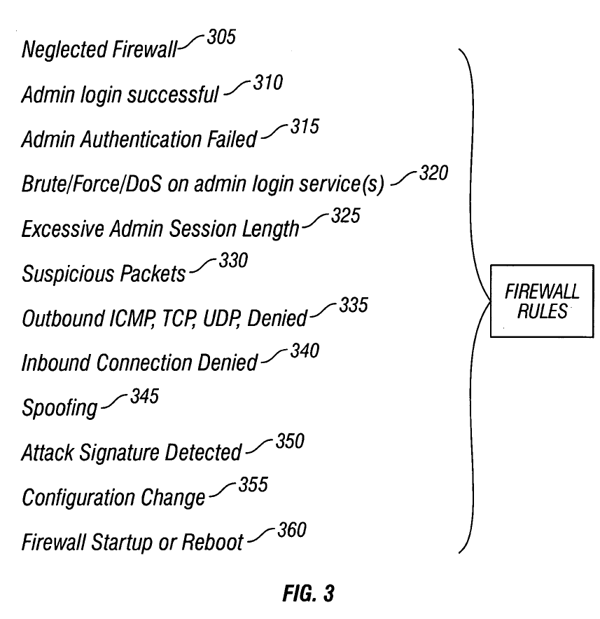

Some special firewall Rules of this embodiment, which convey unique information, are described herein and shown in FIG. 3.

| Rule | Description |
|---|---|
| 1 | Neglected Firewall - no admin logins for |
| | period |
| 2 | Admin login successful |
| 3 | Admin Authentication Failed |
| 4 | Brute Force/DoS on admin login service(s) |
| 5 | Excessive admin session length (abandoned |
| | console) |
| 6 | Suspicious Packets |
| 7 | Outbound ICMP, TCP, UDP Denied |
| 8 | Inbound Connection Denied |
| 9 | Spoofing |
| 10 | Attack Signature Detected |
| 11 | Configuration Change |
| 12 | Firewall Startup or Reboot |
| 13 | Excessive Connections |
| 14 | Fragment Reassembly Overflow |
| 15 | CPU Resource |
| 16 | SNMP Malfunction |
| 17 | TCP Connection Monitor |
| 18 | UDP Connection Monitor |
| 19 | Network Address Translation Monitor |
| 20 | Shunned Source Monitor |
| 21 | DHCP Monitor |

The first rule is the Neglected Firewall rule 305. Firewalls require routine maintenance and configuration. It is expected that each firewall should generate periodic administrative access messages to confirm that such routine maintenance is taking place. This rule generates an alarm after a period of time has elapsed, if no administrative login message has been generated.

Parameters

| Parameter | Description |
|---|---|
| FWID | unique identifier for the |
| | firewall |
| AUTHTYPE | the type of authentication |
| | (e.g. telnet, console etc) |
| SUCCESS | Successful completion |
| MINADMINTIME | maximum amount of time tha |
| | firewall should run without |
| | an administrative access |
| NUMAUTHSUCCESS | number of successful |
| | authentication attempts |
| The rule is: | |
| FOR ALL FWID_AUTHTYPE | |

IF FWID_AUTHTYPE_SUCCESS MESSAGE RECEIVED

FWID_NUMAUTHSUCCESS++

IF FWID_ NUMAUTHSUCCESS != 1 IN
FWID_MINADMINTIME
THEN ALARM

This rule can be repeated for each type of authentication that the firewall is configured to support.

This should generate an alarm having warning level or above, and the period for this alarm should be no more than one month.

Like many of the rules that are described herein, this rule does not describe the characteristics of the information that is being filtered, but rather describes characteristics of the filtering itself.

Rule 2—Administrative Login Successful (310)

Any time a firewall sends a message indicating that administrative access (privileged or lesser level) has been successfully granted, an alarm is generated. The personnel monitoring the security infrastructure are then able to determine when all administrative sessions are started.

| Parameter | Description |
|---|---|
| FWID | unique identifier for the |
| | firewall |
| AUTHTYPE | the type of authentication |
| | (e.g. telnet, console etc) |
| SUCCESS | Successful operation |
| NUMAUTHSUCCESS | number of successful |
| | authentication attempts |

FOR ALL FWID_AUTHTYPE

IF FWID_AUTHTYPE_SUCCESS MESSAGE RECEIVED

FWID_NUMAUTHSUCCESS++

IF FWID_ NUMAUTHSUCCESS > 0
THEN ALARM

This rule can be repeated for each type of authentication that the firewall is configured to support.

Rul 3—Administrativ Login Fail d (315)

Any failed attempt to login to a firewall should be considered as a critical alarm. Administrators may forget or mistype passwords, but any time that happens, the underlying action should be investigated. all such messages should be considered suspicious activity and alarms generated.

| Parameter | Description |
|---|---|
| FWID | unique identifier for the |
| | firewall |
| AUTHTYPE | the type of authentication |
| | (e.g. telnet, console etc) |
| FAILURE | failed operation |
| NUMAUTHFAILURE | number of failed authentication |
| | attempts |
| SRCIP | source IP address |
| AUTHFAILERS | list of IP addresses that fail |
| | authentication |

FOR ALL FWID_AUTHTYPE

IF FWID_AUTHTYPE_FAILURE MESSAGE RECEIVED

FWID_NUMAUTHFAILURE ++

IF FWID_NUMAUTHFAILURE > 0

ADD SRCIP TO FWID_AUTHFAILERS
THEN ALARM

Rule 4—Brut Force/Denial of Service on Login (320)

Any series of multiple failed attempts could indicate that an automated attack is in progress to gain access to the firewall. This situation could also indicate that an automated mechanism for updating the firewall is malfunctioning or is misconfigured.

| Parameter | Description |
|---|---|
| FWID | unique identifier for the |
| | firewall |
| LOGINTIME | an acceptable amount of time that |
| | an authentication should take |
| NUMAUTHFAILURE | number of failed authentication |
| | attempts |
| MAXAUTHFAILURES | maximum number of failures |
| | acceptable |
| SRCIP | source IP address |
| AUTHFAILERS | list of IP addresses that fail |
| | authentication |

IF FWID_NUMAUTHFAILURE > MAXAUTHFAILURES IN
LOGINTIME

ADD SRCIP TO FWID_AUTHFAILERS
ALARM

This is a trend alarm version of Rule 3. All the same messages apply. This rule can be repeated for each type of authentication that the firewall is configured to support.

Rule 5—Excessive Administrative Session Length (325)

When a firewall administrator accesses the firewall in order to view or change the configuration, it is expected that the process will take a finite amount of time. All too often, administrators start an administrative session with the firewall, and then leave the session open after they have completed the configuration change, or distracted by some other emergency. This creates a security risk, since a console or an administrative workstation should never be left unattended while the administrator is logged in.

| Parameter | Description |
|---|---|
| FWID | unique identifier for |
| | the firewall |
| ADMINSESSIONTIME | an acceptable amount |
| | of time to be on the |
| | firewall doing |
| | administrative tasks |
| AUTHSTART | an administrative |
| | authentication was |
| | successfully started |
| AUTHEND | an administrative |
| | authentication ended |
| SRCIP | source IP address |
| CONNECTED_ADMIN_STATIONS | list of IP addresses |
| | that fail |
| | authentication |

IF FWID_AUTHSTART

START ADMINSESSIONTIME
ADD SRCIP TO FWID_ CONNECTED_ADMIN_STATIONS
IF !FWID_AUTHEND IN ADMINSESSIONTIME
ALARM

Rule 6—Suspicious Packets (330)

This firewall rule is more conventional in the sense that it is looking at filtered content, rather than actions of those administering the firewall. A database of suspicious packets may be maintained. Suspicious packets are a class of packets that indicate either attacks, probes, differences in network implementations or malfunctioning equipment. A suspicious packet, by itself, does not indicate an alarm. However, this alarm may allow prediction of locations of possible future attacks. This rule defines setting a threshold and alarming once that threshold is exceeded.

| | |
|---|---|
| FWID | unique identifier for |
| | the firewall |
| SUSPACKETTYPE | the type of suspicious |
| | packet |
| SRCIP | source IP address |
| THRESHOLD | an individual firewall |
| | configurable threshold |
| | above which the alarm |
| | is generated |
| POLY | applies to all or a |
| | group of firewalls |
| SUSPACKETSOURCES | an array of IP address |
| COUNT | a running counter |

FOR ALL FWID_SUSPACKETTYPE

IF FWID_ SUSPACKETTYPE MESSAGE RECEIVED

FWID_SUSPACKETTYPE_COUNT++
ADD FWID_SUSPACKETTYPE_SRCIP TO FWID_{—}

SUSPACKETSOURCES
IF FWID_SUSPACKETTYPE_COUNT >
FWID_ SUSPACKETTYPE_THRESHOLD

ALARM

Another aspect of this rule includes determining trending of the number of the suspicious packets. If the number of suspicious packets increases sharply, this may indicate the beginning portions of an attack. This rule may also be effected by the intrusion detection module, which also includes trending capabilities.

Suspicious packets can also be monitored across multiple firewalls. If suspicious packets are being received by multiple firewalls from the same source, an alarm is generated, and the source IP address is logged.

FOR ALL FWID

FOR ALL SUSPACKETTYPE

IF FWID_SUSPACKETTYPE_COUNT > 0

POLY_ SUSPACKETTYPE_COUNT++

IF POLY_ SUSPACKETTYPE_COUNT > 2

FOR ALL FWID

FOR ALL SUSPACKETSOURCES

IF FWID_SUSPACKETTYPE_SRCIP MATCH

ALARM

When multiple firewalls receive suspicious packets from the same IP address or network the criticality should increase. When one IP address or network repeatedly generates suspicious packet alarms, the alarm level should also be increased.

The response by the security infrastructure should include identifying the packets, determine the source, why they are being sent and possibly contacting the remote network administrator. The informational display for such an alarm should describe the packet and the source. If multiple packets are received from the source, then access to the historical packet log should be made available. By analyzing the packet(s) the monitoring administrator can determine if attack or probe activity is in progress or if equipment is malfunctioning or incompatible. Possible secondary response might be shunning the source IP address or network.

Rule 7 Outbound ICMP, TCP, UDP Denied (335)

This rule is a warning label rule which is carried out any time any user attempts to make a connection which is not allowed by the firewall rules. This may be an indication that an attempt is being made to compromise the firewall. Again, this is not a critical alarm by itself, since this may simply indicate legitimate access attempts.

Rule 8 is the corresponding analogue for the outbound connection.

Rule 8 Inbound Connection Denied (340)

The inbound connection denied rule tracks inbound connections that are denied by the Firewall Rules (the firewall policy).

As in the above, a denied inbound connection does not necessarily mean a serious situation. However, correlation among the different denied connections may provide patterns that provide more interest. For example, correlation among the following elements of the rejected packet and rejected packet stream may be used:

source IP address

destination IP address

destination port

protocol (ICMP, IP, TCP, UDP)

protocol specific flags or packet settings

frequency

Ongoing statistics and trend information on rejected packets may provide insight into the specific vulnerabilities being probed for and the frequency of the probing. In general the lower the probe the more patient (and potentially sophisticated) the attacker is. Being able to analyze (slice and dice) the rejected packet history provides insight into the types of vulnerabilities are being probed for and therefore the attacks that might be encountered in the future. An important aspect of this analysis, therefore, is to realize that a highly suspicious action which occurs infrequently may still be a warning of possible intrusion.

Source IP Address

This rule saves at least the following lists. A first list is the source IP address list which is saved and correlated based on the source network. If too many packets come from a specific source network, (possibly over multiple IP addresses), then the network management system can shun or black list the network as a whole. Over time, network probes or host scans that occur at low frequency or from a distributed set of probing/scanning computers can be identified and alerted on. Monitoring source IP address also allows the network administrator to contact the administrative counterparts in the source network so that malfunctioning or mis-configured systems can be fixed.

Destination IP Address

By tracking the destination IP address of rejected packets, administrators can determine if specific systems or networks are being attacked. Excessive numbers of otherwise legitimate rejected packets might also indicate routing or DNS problems in the network or relating to the protected network.

Destination Port

Tracking the destination ports of rejected packets allows detection of network probes, of the so-called war dialer type. This is another trending alarm, in which rejected packets that are systematically received may be used to detect network probing.

Protocol

The firewall rejects different packets for different reasons. Some firewalls have built in suspicious packet identification logic. The identification of suspicious packets can take place at the network (hardware) or protocol layer (IP, TCP etc) thus resulting in rejection taking place at different stages of the firewall packet processing. By monitoring statistics and trends on packet type the network management system can identify attack trends or vulnerability probes that are attempting to exploit packet specific vulnerabilities.

The protocol of the rejected packet provides insight into the application level of vulnerabilities being probed. For example, excessive HTTP packet rejects might be a probe for a vulnerability in the web server.

Protocol Specific Flags

Many vulnerabilities are the result of application and system programmers not anticipating various combinations of protocol specific flags. By counting and trending rejected packets based on protocol specific flags, existing and future application vulnerabilities can be tracked.

Parameters and Rule

| | |
|---|---|
| Parameter | Description |

| | |
|---|---|
| FW_ID | Unique identifier for the firewall |
| DENIED | a packet was denied or rejected |
| SRCIP | Source IP address |
| SRCPORT | Source port |
| DESTIP | destination IP |
| DESTPORT | destination port |
| PROTOCOL | protocol identifier |
| PROTOCOLFLAGS | protocol flags parameter |
| | (appropriate for protocol) |
| COUNT | a running counter |
| REJECTEDHOSTS | array of IP addresses that sent denied |
| | packets |
| PERIOD | period of time (e.g. 60 seconds, 1 hour, |
| | 24 hours, Month) used to store events per |
| | period |
| PERIODVARIABILITY | a percentage representing a slope change |
| | that indicates either a rapid positive or |
| | negative change in rejected packets over |
| | a period |
| TIME | a timestamp |
| DENIEDLIMIT | a threshold indicating the number of denied |
| | packets are acceptable from a foreign host |
| THRESH_PERIODS | A number of periods for which a parameter |
| | sampling is considered “required” to |
| | form a trend |

IF CONNECTION_DENIED MESSAGE RECEIVED

COMPUTE FIREWALL STATISTICS

FW_ID_DENIED_COUNT++

FOR EACH PERIOD

UPDATE FW_ID_DENIED_PERIOD
(CALCULATE DENIED PACKETS/FW/PERIOD)
IF DEVIATION IN FW_ID_DENIED_PERIOD > PERIODVARIABILITY
ALARM ON PERIOD
IF PERIOD EXPIRED RESET PERIOD COUNTER
COMPUTE/EVALUATE SOURCE STATISTICS
FW_ID_SRCIP_DENIED_COUNT++
IF SRCIP NOT IN FWID_REJECTEDHOSTS

ADD SRCIP TO FWID_REJECTEDHOSTS
PERFORM NETWORK SOURCE ANALYSIS - DETERMINE IF > 1 SRCIP IS IN A NETWORK
IF >1 SRCIP IN A NETWORK

ALARM ON NETWORK

FOR EACH PERIOD

UPDATE FW_ID_SRCIP_DENIED_PERIOD

(CALCULATE DENIED PACKETS/SRCIP/PERIOD)

FOR EACH PERIOD EVALUATE FW_ID_SRCIP_DENIED_PERIOD
(FOR EACH PERIOD AN NUMBER OF PERIODS MUST BE CONSIDERED)

IF SLOPE IS POSITIVE

ALARM ON PERIOD (AUTOMATED SCAN OR ATTACK)
IF SLOPE IS POSITIVE AND INCREASING

ALARM ON PERIOD (INCREASING FLOOD OF PACKETS)

FOR EACH PERIOD

PERFORM CLEANUP (RESET PERIOD COUNTERS ETC, IF NO ACTIVITY FROM

SOURCE

FOR AN EXPIRE PERIOD, MOVE STATISTICS TO HISTORICAL)

COMPUTE DESTINATION STATISTICS

REPEAT ABOVE ANALYSIS FOR DESTINATION ADDRESSES

COMPUTE PROTOCOL STATISTICS

REPEAT ABOVE ANALYSIS FOR EACH PROTOCOL(PORT) AND PROTOCOL FLAG

COMBINATION

The above rule evaluates denied packet statistics based on source IP, destination IP, protocol and protocol flags. The rule may generate a series of graphs based on frequency of received packet properties.

For a group of time PERIODS (e.g., at intervals of 1 second, 1 minute, 1 hour, 1 day, 1 week and 1 month), each graph is updated as incoming denied packet messages are received by the engine. For each PERIOD a sliding evaluation window is considered, in order to determine trends in the denied packet activity. The trends identified in the rule above include positive or increasing slope. More generally, any a deviation from a standard activity graph for the window may could also generate an alarm over any of the multiple time periods.

The criticality of this alarm is based entirely on the condition of its trending. Limits may be set on the amount of slope change, with a very high change in slope representing higher level alarms. For example a rapidly increasing slope for denied packets per second may indicate a flood and is definitely something the operator should be alerted to. In addition, however, positive consistent slope across multiple minutes, hours and days would also be a trend that the operator should be alerted to. Each PERIOD is assigned a THRESH_PERIODS which indicates the window that would most likely determine a threatening trend for the sample rate. The goal of the rule is to alert on floods but also long period consistent probes. In general, high your criticality alarms are established by a trend which continues for more periods. A positive consistent slope below 1 should be advisory if the trend continues more than 5 periods. If the slope change indicates a logarithmic or geometric positive trend, the alarm should go critical. For each period a set of configurable evaluation criteria should be provided.

In response to a inbound connection denied alarm, the operator should view the source IP, packet type and protocol and attempt to determine how the packet got to the firewall. In the case of DoS attacks, the source IP or source network should be shunned at an external router, if possible, to relieve processing on the firewall. The source network administrative contacts should be notified and possible network/host problems diagnosed and solved.

Rule 9—Spoofing Detected (345)

Spoofing is a general term applied to packets or sessions that contain a source address that is different than the actual address of the systems sending the packet or participating in the session. An attacker might try to circumvent the firewall by modifying the packets to make them appear that they are from the internal protected network or a trusted external source.

The present system uses both deterministic and non-deterministic spoofing rules. For example, one deterministic rule is to automatically deny any packet received by an external interface that has a source address indicating the internal network.

One nondeterministic rule is a decision by the firewall to reject a packet based on a guess that the source address could not have originated from an interface based on the routing tables associated with that interface. The spoofing rule presented below is a basic alarm that will alert an operator if a spoofed packet is received. Spoofed packets are generally associated with DoS attacks and Distributed DoS attacks. Statistics can be generated, but in general even one spoofed inbound or outbound packet represents a dangerous situation.

| Parameter | Description |
|---|---|
| FW_ID | unique identifier for the |
| | firewall |
| INTERFACE | an identifier for the |
| | interface |
| SPOOFED | a spoofed packet was |
| | detected |
| COUNT | a running counter |
| SPOOF_THRESH | a threshold above which |
| | the number of spoofed packets |
| | is considered critical |
| | (used in addition to a |
| | one hit alarm) |

IF FW_ID_SPOOFED PACKET RECEIVED

IF FW_ID_INTERFACE IS INTERNAL
(TRUSTED NETWORK)
FW_ID_SPOOFED_INTERFACE_COUNT++
ALARM OUTBOUND SPOOFED PACKET DETECTED
IF FW_ID_INTERFACE IS EXTERNAL
(UNTRUSTED NETWORK)
FW_ID_SPOOFED_INTERFACE_COUNT++
ALARM INBOUND SPOOFED PACKET DETECTED
FOR ALL FW_ID_INTERFACE

IF FW_ID_SPOOFED_INTERFACE_COUNT >
FW_ID_SPOOF_THRESH
ALARM SPOOF THRESHOLD EXCEEDED

Rule 10—Attack Signature Detected (350)

Many firewalls have the ability to detect attacks based on a detailed examination of the packet or the session, described in further detail herein as part of the network intrusion system. However, when it detection of attack signatures is enabled on the firewall, the firewall is acting as a network based intrusion detection system (NIDS). Hence, this places an additional computational burden on the firewall.

The rule presented below is for those firewalls that have network intrusion detection system enabled. Note that the suspicious packets rule will also detect some existing or new attacks. As with the inbound connection denied rule the source IP address for any detected attack signature should be correlated into a network address to determine if a particular network should be shunned or banished together.

Parameters

| Parameter | Description |
|---|---|
| FW_ID | unique identifier for the |
| | firewall |
| INTERFACE | an identifier for the |
| | interface |
| SRCIP | source IP of the attack |
| COUNT | a running counter |
| ATTACK | an attack message |
| SIGNATURE | a unique identifier for |
| | the attack |
| ATTACKERS | an array of IP addresses |
| | from which attacks have |
| | been detected |
| ATTACK-THRESH | a threshold above which the |
| | number of attacks is considered |
| | critical (used in addition to |
| | a one hit alarm) in general |
| | the more well known or |
| | distributed attack programs |
| | can have a higher threshold value |

IF FW_ID_ATTACK MESSAGE RECEIVED

FW_ID_ATTACK_COUNT++
FW_ID_ATTACK_SIGNATURE_COUNT++
ADD SRCIP TO FW_ID_ATTACKERS

COMPUTE FIREWALL STATISTICS
IF FW_ID_ATTACK_COUNT > FW_ID_ATTACK_THRESH

ALARM FIREWALL HAS RECEIVED TOO MANY
ATTACKS

COMPUTER ATTACK STATISTICS
IF FW_ID_ATTACK_SIGNATURE_COUNT >
FW_ID_SIGNATURE_ATTACK_THRESH

ALARM FIREWALL HAS RECEIVE TOO MANY
SIGNATURE ATTACKS

COMPUTE SOURCE STATISTICS
FOR ALL SRCIP IN FW_ID_ATTACKERS

IF FW_ID_SRCIP_ATTACK_COUNT >
FW_ID_SRCIP_ATTACK_THRESH
ALARM SRCIP MAKING TOO MANY ATTACKS

PERFORM NETWORK ANALYSIS
FOR ALL SRCIP IN FW_ID_ATTACKERS

IF THE NUMBER OF SRCIP IN ONE CLASS C
NETWORK > 2
ALARM NETWORK IS SENDING TOO MANY ATTACKS

It should be noted that all analysis of attack signature should be considered limit based. The number of automated attacks available in precompiled and source code form assures that attacks will always be detected. It is normal to periodically receive well-known attacks. Only when that number exceeds a threshold should this be considered as a problem. However, Attacking system IPs should be kept historically. IPs should only be removed after a period of time elapses that is proportional to the number of attacks received. For example, if one attack is received from an IP address this IP could be removed after a twenty four hour period. But if one hundred attacks are received, this IP address could be removed after 3 months.

If an attack can be detected, it can be assumed that the bug that the attack exploits has been fixed or a network configure change is initiated to neutralize the attack. For this reason, the main purpose of attack signature received message monitoring is to identify IPs and networks from which attacks are common and likely. With this information administrators can shun or restrict access from these networks. A typical example might be to restrict a school lab network at the external network router after it has been determined to be the source of ongoing attack activity.

The criticality of any detected attack signature increases with the number of detected attacks. The rule above defines a single threshold but in an embodiment, at least three thresholds should be implemented. One detected attack should be advisory, twenty five should be considered a warning and over one hundred should be considered critical.

Rule 11—Configuration Change (355)

Over time, the firewall administrator will need to make changes to the firewall. Each time a rule is modified or software/firmware is upgraded the firewall will generate a message indicating that the firewall configuration has changed. It is important to track configuration changes in the network. Each time the configuration changes the administrators monitoring the security architecture should qualify the configuration change in one of the following categories:

routine change for maintenance

configuration change implemented in response to an attack

software/firmware change in response to an attack

software/firmware change for upgrade

Each type of change should be monitored and alarms should be generated in response to changes or lack of changes. This is similar to the administrative login monitoring rules above. Some firewalls will routinely reboot and load a configuration from a configuration server. In this case configuration changes are pushed to the configuration server and propagated out to the firewalls, which are then hence administered directly. The configuration change rules below generate alarms such that anticipated and unanticipated changes are monitored for success or failure to execute.

Parameters

| Parameter | Description |
|---|---|
| FW_ID | unique identifier for the firewall |
| CHANGE | a configuration change message |
| CHANGETYPE | a unique identifier for the change type- |
| | (e.g. auto, manual, bootp, console-push) |
| COUNT | a counter |
| CONFIGPERIOD | a period of time over which a |
| | configuration change should take place |

IF FW_ID_CHANGE MESSAGE RECEIVED

FW_ID_CHANGETYPE_COUNT++
ALARM FW_ID CHANGETYPE DETECTED

FOR ALL FW_ID

ID NO CHANGE MESSAGE RECEIVED IN CONFIGPERIOD
ALARM CONFIGURATION UPDATE OVERDUE

Any firewall configuration change is critical. A lack of a firewall configuration change in a reasonable period of time could mean that the firewall software/firmware is not being maintained, so therefore a lack of a configuration change is also a critical alarm.

attack and balance situation can be used by providing the alarm to a group that is distinct from the group that maintains the firewall configuration. Therefore, a configuration change message created by one person operating the firewall is received by a different person monitoring the security infrastructure.

Rule 12—Firewall Startup or Reboot (360)

In the course of operations, any time a firewall stops or starts, a critical alarm should be generated. The firewall provides critical parts of the security architecture. A firewall that goes offline or is coming online is a critical concern for those who are responsible for configuring and maintaining the firewall and for those responsible for monitoring the firewall. Rule 12 is a specific case of Rule 11 because in the macro sense the firewall start and stop is a configuration change.

Parameters

| Parameter | Description |
|---|---|
| FW_ID | a unique identifier for the firewall |
| STARTUP | a startup message |
| COUNT | a running counter |

IF FW_ID_STARTUP MESSAGE RECEIVED

FW_ID_STARTUP_COUNT++
ALARM FW_ID STARTUP

Startup trends may also be monitored according to this rule. For example, a poorly designed ruleset might require more maintenance and thus more firewall restarts. Trend analysis might include checking the slope of the startup frequency per week. A positive slope indicates a constant change or a rise in configuration changes.

Any firewall restart is a critical event. A positive change in restart frequency as sampled periodically (weekly recommended) might also indicate a problem with the firewall software/hardware (a bug), a poorly designed configuration, a badly managed network (requires too many changes to the border) or a malfunctioning network. All of these are critical.

The response to a firewall startup should be that the monitoring administrator should investigate the startup and determine if it was manual or automated. Then the administrator should determine the root cause of the change and investigate as appropriate. At that point the alarm should be cleared.

### Network Intrusion Systems

Network Intrusion Detection System (NIDS) are devices that monitor network traffic and generate alarm messages when they detect suspicious patterns in the content of the traffic. As each packet is read from the network, information from the packet is analyzed. The packet is evaluated in a logic tree to determine if the packet is part of a known attack sequence. This “attack sequence” is called an attack signature. The packet and the sequence containing the packet may also be evaluated against a model “normal traffic pattern” in order to detect anomalies.

Network based attacks exploit programming errors that cause network applications to behave in unexpected ways when they are provided with anomalous packets. Hackers use programs to generate attack sequences and anomalous packets with the intent to:

Gain useful intelligence about the target system or network (scans)

Cause a program on the target system to crash

Gain access to information on the target system

Gain interactive access to the target system (privileged or non-privileged)

Cause excessive activity on the target system (Denial of Service attack).

A program that generates the attack sequence is generally referred to as an attack tool or “exploit”. Exploit programs can be simple or complex depending on the bug or vulnerability that is being exploited. Exploits evolve over time and constitute a significant development effort in the hacker community. network intrusion detection system manufacturers maintain and distribute an increasing number of attack signatures that are used by their products to detect exploits on the network.

As new network services and systems are deployed, the aggregate network traffic changes over time. Each new service introduces new vulnerabilities into the network infrastructure.

Network services are accessible from the enterprise network, the Internet or both, which increases the number of potential sources for attack sequences. This makes attack sequences and anomalous packets more difficult to distinguish from normal network traffic.

Many exploit programs are available for download on the Internet. Many would-be hackers (also known as script-kiddies) download, compile and run exploits with little understanding of the vulnerability or target system. On Internet accessible systems, this results in a constant stream of attack sequence alarms from the NIDS. Attack sequences can be directed at systems that do not exist or do not run the service that is vulnerable to the attack. Attack sequences can be directed as systems that are no longer vulnerable because the system has been reconfigured or upgraded (bug fixes and patches). Attack sequences that cannot be successful or normal traffic that is misinterpreted by the network intrusion detection system are collectively called false positives.

Once an intrusion is detected, it is often qualified, to make a detection of exactly what is happening. This can be difficult, however, because the information about the attack can reside on multiple systems such as rather logs, firewall logs, application server logs, and the like. Once the attack is adequately determined, appropriate responses to the attack can be carried out such as applying a patch to avoid the network vulnerability, locking vulnerability report with the vendor, reconfiguring network routers, or reconfiguring the target system. However, the speed with which new attacks can be launched may make the administrator's task a daunting one.

A host-based intrusion system may also be used by detecting changes in the host software running on the host.

Rules for network detection are well-known, and the following rules are special rules that are outside of the usual way in which network intrusion is carried out.

The network intrusion detection system rule parse the network intrusion detection system messages into a normalized format. Alarms are generated based on:

parameters populated from the normalized content of the alarm messages

parameters populated from databases (NOD, KAD, NAD and NSM see next section)

analytical parameters derived from combinations of message content and values in the objects database

trends identified by successive parameters and analytical parameters

To support the rules, data structures are created and maintained to store historical data and information about the network and network nodes. The rules refer to these data structures as “databases”.

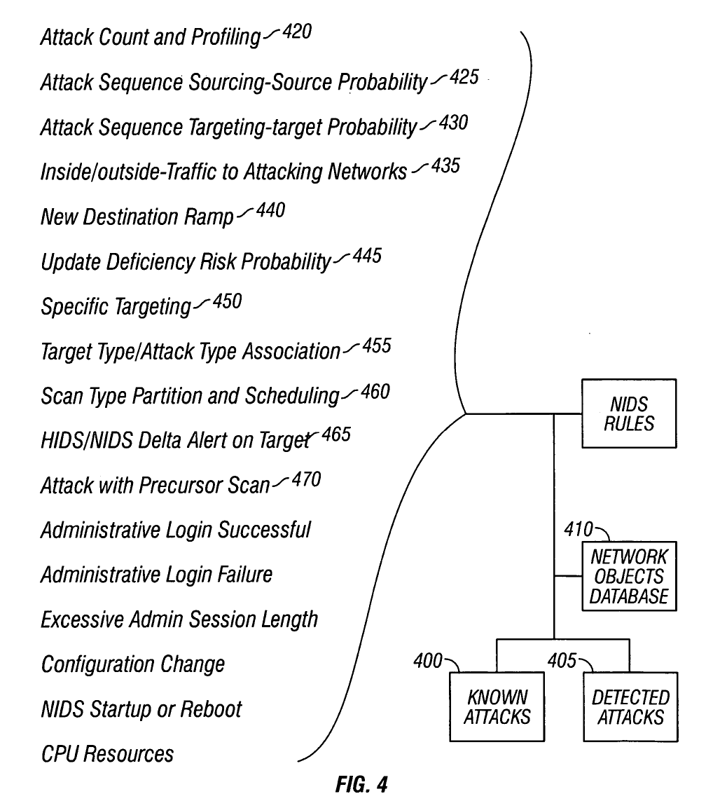

The Known Attacks Database (KAD) is shown as 400 in FIG. 4, and is a data structure that contains information about the universe of known attacks. The KAD information defines systems affected, signature data, attack packet syntax, variant taxonomy, critically and countermeasures. This database can be used as a reference for the operator and as a source of parameter values during real-time operation. Over time this database evolves to include new information about new attacks that are detected and classified.

The Detected Attacks Database 405 is a domain centric database, that depends on the size and logical divisions in the monitored network.

Each device on the network including hosts, routers, switches and security devices is recorded in the Network Objects Database 410 (NOD). The NOD information includes device specific information including model, OS software versions, application software versions and pertinent configuration information (IP addresses, interfaces etc). The NOD provides network and target based parameters used to make real-time decisions about attacks.

N twork S gment Map

Each Network Intrusion Detection System is deployed on a segment of the network, where a segment is defined as a portion of the network, separated from other portions by a router. A network map, and list of IP addresses that are accessible from that network segment is made available. Network Segment Map is calculated from this information.

For example, consider a three zone enterprise network based on the Internet, DMZ and the corporate network. The Internet should only be able to access specific DMZ IP addresses. The DMZ should be able to access the Internet and specific IP addresses (management systems) on the Corporate Network. The Corporate Network has access to itself and the Internet. Each zone should have a network map associated with the destination IP traffic that is possible based on source IP address.

Each segment of the map has two lists, the on-this-segment list and the accessible host list.

Correlation in a technical sense is taking two or more distinct informational messages and deducing new information from them. Aggregation as correlation is the process of presenting two or more distinct informational messages via a common interface so that the operator can more easily make deductions from them. This is discussed in more detail in the “correlation” section.

For efficiency and logical grouping, network intrusion detection system rules that utilize correlation are presented in this section and are indicated by an asterix “*” in the rule name header.

These guidelines assume all messages are translated into a common format or “normalized.” Normalization is a key component of analyzing network intrusion detection system messages from a variety of different network intrusion detection system technologies.

| Rule | Description |
|---|---|
| 1 | Attack Count and Profiling |
| 2 | Attack Sequence Sourcing - Source Probability |
| 3 | Attack Sequence Targeting - Target Probability |
| 4 | Inside/Outside - Traffic to Attacking Networks |
| 5 | New Destination Ramp |
| 6 | Update Deficiency Risk Probability |
| 7 | Specific Targeting |
| 8 | Target Type/Attack Type Association |
| 9 | Scan Type Partition and Scheduling |
| 10 | HIDS/NIDS Delta Alert on Target |
| 11 | Attack with Precursor Scan |
| 12 | Administrative Login Successful |
| 13 | Administrative Login Failure |
| 14 | Excessive Admin Session Length |
| 15 | Configuration Change |
| 16 | NIDS Startup or Reboot |
| 17 | CPU Resource |

Note:
Rules 12-17 are the same as the Firewall rules, given above

Rule 1—Attack Count and Profiling (420)

Network Intrusion Detection Systems identify attacks using attack signatures or anomalous behavior models. The goal of the network intrusion detection system rules is to provide information about the context in which the attacks are taking place. A primary concern is to qualify all incoming attack alarms based on the following criteria:

Attack name

Operating system, device type and version affected

Application and version affected

Attack classification (scan, brute-force, D/DoS, overflow, logic bomb)

Attack life span (time from first identified to current detection time)

Target specificity (does it affect a host or is it a scan of multiple hosts)

Operating System or application patch countermeasure identification)

This rule populates the database of detected attacks.

Parameters

| | |
|---|---|
| ATTACK_NAME | The name of the attack (see |
| | www.mitre.org for Common |
| | Vulnerabilities and Exposures) |
| VULNERABLE_OS | Operating systems vulnerable |
| | to this attack |
| VULNERABLE_APPLICATION | Applications vulnerable |
| | to this attack |
| INCEPT | Date of initial discovery |
| | of attack or variant |
| SPECIFICITY | Affects host or network |
| CLASSIFICATION | An attack classification |
| COUNTERMEASURE | Patch or update that |
| | addresses vulnerability |
| NEW | Binary, An attack is new if it |
| | is not in the detected attacks |
| | database. An attack remains |
| | “new” until it is manually |
| | changed by the operator to |
| | a known status |
| CRITICALITY | A rating for the attack that |
| | indicates it's danger level |
| | subject to patching (harmless, |
| | dangerous, unknown-new) |
| COUNT | A running counter |
| TARGET | The target of the attack |
| HISTORICAL_TARGETS | Array of target IP/Network |
| | Addresses |

IF ATTACK MESSAGE RECEIVED
IF ATTACK_NAME NOT IN KNOWN ATTACK DATABASE(KAD)

SET ATTACK_NAME_NEW = TRUE
ALARM “NEW ATTACK OPERATOR POPULATE DAD, KAD.
ANALYZE” EXIT PROCESSING

IF ATTACK_NAME NOT IN DETECTED ATTACKS
DATABASE(DAD)

CREATE RECORD OF THE ATTACK IN DETECTED
ATTACK DATABASE
POPULATE DAD FROM KAD

ATTACK_NAME_COUNT++
IF ATTACK_NAME_TARGET NOT IN HISTORICAL_TARGETS

ADD ATTACK_NAME_TARGET TO ATTACK
HISTORICAL_TARGETS

ATTACK_NAME_TARGET_COUNT++
CONTINUE
Note: The ATTACK message will now pass through other rules

This rule will only alarm when an attack is a new attack; known attacks are handled by the known attacks database.

Once populated in this way, the database can be used in identifying other attacks. Many of the following rules make use of this first rule and its database operations.

Rule 2—Attack Sequencing Sourcing—Source Probability (425)

Over time, the network intrusion detection system identifies a large number of attack sequences. This rule analyzes the source IP address, and other information, of all attack sequences to identify which networks are more likely to generate attacks. The IP address or network from which attacks originate can then be used to qualify ongoing and future attacks.

A large number of attacks from a specific IP address or network indicates a group of attackers or script-kiddies. A large number of canned well-known attacks originating from a specific network do not necessarily constitute a threat.

The vulnerabilities which these attacks are attempting to exploit might not exist on the target host or network. But, a high number of attacks from a specific network or IP address might identify a network where exploits are actively being developed or modified, therefore special attention should be paid to such networks.

This rule monitors exploit activity based on the quantity of attacks originating from specific IP address or network.

| Parameter | Description |
|---|---|
| ATTACK_NAME | The name of the attack (see |
| | www.mitre.org for Common |
| | Vulnerabilities and Exposures) |
| SRCIP | The source IP address of the attack |
| NETWORK | Origin Class C network of the SRCIP |
| | Address AND (SRCIP, ff.ff.ff.0) |
| NETBLOCK | Allocated Netblock from whois record |
| DOMAIN | Allocated IP domain from whois |
| | record if applicable |
| WHOISRECORD | Pointer to locally stored whois |
| | record (refreshed periodically) |
| ORIGINATINGATTACKS | An array of attack names |
| NEWCOUNT | A running counter of new attacks |
| DISTINCTCOUNT | A running counter of the number |
| | of distinct attacks originating |
| | from the source |
| COUNT | A running counter |
| ATTACKTOTAL | An aggregate total of all attacks |
| TIMESTAMP | The time of the attack |
| ATTACKTIME | An array of timestamps |
| KNOWNATTACKNETS | An array of NETWORKS that |
| | have attacked |
| AP | Attack probability for source |

Continue from previous processing
IF ATTACK MESSAGE RECEIVED
FOR SOURCE IN {SRCIP, NETWORK, NETBLOCK, DOMAIN}

START
SOURCE_ATTACK_NAME_COUNT++
ADD ATTACK_TIMESTAMP TO SOURCE_ATTACKTIME

IF ATTACK_NAME NOT IN SOURCE_ORIGINATINGATTACKS

SOURCE_DISTINCTCOUNT++
ADD ATTACK_NAME TO SOURCE_ORIGINATINGATTACKS

IF ATTACK_NEW

SOURCE_NEWCOUNT++
SOURCE_ATTACKTOTAL++
PLOT ALL SOURCE_ATTACKTIME
END

ADD NETWORK TO KNOWNATTACKNETS
CALCULATE AP FOR NETWORK PERIODICALLY (A PERIOD
BASE ON N HOURS WHEN N IS
BETWEEN 1 AND 12
ALARM ON NETWORK_AP CRITICALITY BASED ON CURRENT
THRESHOLD(ADVISORY, WARNING,
CRITICAL)

An abstract Source Attack Probability (AP) can be generated for each network is identified as the source of an attack. This can be repeated for other groupings of IP addresses.

AP is calculated by applying positive and negative delta factors to the current AP. Attacks have a positive delta factor. Successive time periods without any received attacks will apply a negative delta factor to AP.

Known attacks and attacks classified as non-dangerous can be assigned a lower positive delta factor (resulting in an increase in the probability) when computing AP. Attacks classified as dangerous can be assigned a higher positive delta factor. New attacks will have the highest positive delta factor.

Negative delta factors for AP can be time based on an inverse exponential back off. Based on a period if no attacks are received the negative delta factor is applied in ever increasing magnitude until AP becomes zero.

As AP crosses predefined thresholds, the source network danger level changes proportionately. Advisory, warning and critical alarms can be generated for each threshold. AP can be a parameter used to indicate the threat level of new attacks when it is necessary to prioritize attack investigations.

Rule 3—Attack Sequence Target Qualification (430)

The rule analyzes the target IP address or network of an attack. Factors that influence alarm priority with respect to target IP address include:

Is the target a legitimate destination on the network?

Is the target a legitimate destination but is otherwise not accessible by the attacker

Are the source internal and the target external?

Are successive different attacks occurring on this target

As each attack alarm is processed, trending on target IP address will help determine the probability of future attacks. Scans are a specific type of attack and are analyzed with a different rule.

Parameters

| Parameter | Description |
|---|---|
| ATTACK_NAME | The name of the attack (see for Common |
| | Vulnerabilities and Exposures) |
| NIDSID | THE network intrusion detection |
| | system ID |
| TARGETIP | The IP address of the target system |
| NSM (NIDSID) | The Network Segment Map entry |
| | for the segment monitored by the |
| | reporting NIDS |
| SRCIP | The source IP of the attack |
| ONSEGMENT | The list of IP addresses on the |
| | segment (External if network |
| | intrusion detection system outside |
| | of firewall on the Internet) |
| ACCSEGMENT | The list of IP addresses accessible |
| | from the segment |
| NETIPLIST | The list of all IP addresses in the |
| | network (behind the firewall) |

Continue from previous processing
IF ATTACK MESSAGE RECEIVED
IF(TARGETTIP NOT IN NETIPLIST AND NSM(NIDSID)_{—}
ONSEGMENT != EXTERNAL)

ALARM “ATTACKING EXTERNAL IP” EXIT

IF(TARGETIP NOT IN NSM(NIDSID)_ACCSEGMENT AND
SRCIP NOT IN
NSM(NIDSID)_ONSEGMENT)

ALARM “LOST ATTACK PACKET OR SPOOFED

SOURCE ATTACK” EXIT
IF (TARGETIP IN NETIPLIST AND TARGETIP NOT IN
NSM(NIDSID)_ACCSEGMENT)

ALARM “NETMAP COMPROMISED BY ATTACKER” EXIT

Rule 4—“Inside/Outside—Traffic to Attacking Networks (435)

This rule analyzes outgoing traffic patterns and compares them to known attacking networks. This rule assumes that outbound network traffic is being monitored. external networks will be weighted based on the number of received attacks based on the number of attack messages are received and processed from the IDS. When outbound traffic to one of these networks is detected, an alarm is generated. This is a trend/correlation rule that hence requires historic data from multiple security device classes over time.

Parameters

| Parameters | Description |
|---|---|
| SRCIP | The source IP of the packet |
| DESTIP | The destination IP of the packet or |
| | connection |
| NETIPLIST | The list of all IP addresses in the |
| | network (behind the firewall) |
| KNOWNATTACKNETS | An array of NETWORKS that have |
| | attacked (from Attack Sequence |
| | Sourcing rule) |

WHEN AN OUTGOING PACKET IS RECEIVED OR CONNECTION
ESTABLISHED MESSAGE RECEIVED
IF SRCIP NOT IN NETIPLIST

ALARM “UNAUTHORIZED IP SOURCE(POSSIBLY SPOOFED)”

IF SRCIP IN NETIPLIST AND (DESTIP AND FF.FF.FF.00)
IN KNOWNATTACKNETS

ALARM “OUTGOING CONNECTION TO KNOWN
ATTACKING NETWORK”

Rule 5—“New Destination Ramp” (440)

This rule analyzes outgoing traffic patterns to determine how traffic to new destinations behaves. The goal of the rule is to attempt to detect automated communications from compromised systems.

This rule starts by qualifying the outbound traffic destination as known or unknown (e.g. finance.yahoo.com=known.zephyr.dawsoncmpsilab.dawson2.uhelsinki.fn.edu=unknown). The traffic is qualified as normal or abnormal (e.g. http=normal, unknown-protocol to port 37337=abnormal and http to port 62000=abnormal). Trending is used to determine how new outbound destinations are accessed based on time, amount of traffic and frequency of traffic. This rule may be able to distinguish between normal traffic to new network services such as a new travel web site and a new virus that is broadcasting stolen information to a remote collector.

Parameters

| Parameters | Description |
|---|---|
| KNOWNPROTOCOLS | An array of protocol n-tuples |
| | that defines known normal |
| | traffic (e.g. http, 80, 8080) |
| NEWPROTOCOLS | An array of protocol n-tuples |
| | detected but not known protocol |
| | array |
| PACKETPROTOCOLDESC | An n-tuple derived from the |
| | packet or connection that can |
| | be added to KNOWNPROTOCOLS or |
| | NEWPROTOCOLS |
| PACKETPROTOCOLID | An unique identifier for a |
| | protocol, port combination |
| SRCIP | The source IP of the packet |
| DESTIP | The destination IP of the |
| | packet or connection |
| DESTNETWORK | The destination network of |
| | the packet or connection |
| KNOWNDESTINATIONS | An array of NETWORKS to have |
| | historically received outgoing |
| | packets or connections |
| COUNT | A running counter |

WHEN AN OUTGOING PACKET IS RECEIVED OR CONNECTION
ESTABLISHED MESSAGE RECEIVED
POPULATE PACKETPROTOCOLDESC(PROTOCOL AND
DESTINATION PORT INFO, PROTOCOL
MIGHT BE UNKNOWN)
IF PACKETPROTOCOLDESC NOT IN KNOWNPROTOCOLS

ASSIGN PACKETPROTOCOLID
ADD PACKETPROTOCOLDESC TO NEWPROTOCOLS
ALARM “NEW PROTOCOL PACKET DESCRIPTOR” EXT

DESNETWORK = DESTIP AND FF.FF.FF.00
IF DESNETWORK NOT IN KNOWNDESTINATIONS

ALARM “NEW DESTINATION FOR PACKETPROTOCOLID”
(ALARM TRENDS AFTER FIRST

HIT)
NETWORK_PACKETPROTOCOLID_COUNT++
TREND NETWORK_PACKETPROTOCOLID_COUNT
TRENDING NETWORK_PACKETPROTOCOLID_COUNT

Normal network traffic is used to develop identifiable normal hourly, daily, weekly and monthly trends. As each new PACKETPROTOCOLID is identified, a trend should be established within one of the time frames analyzed. When a deviation in slope in the timeframe plot occurs after the trend is established, an alarm should be generated to alert the operator that a change in the traffic pattern has been identified. Alarms can also be set as counts pass between different operator definable frequency thresholds. For sporadic traffic, thresholds can time expire to default levels (typically lower) so that short term trends do not obscure future alarms on frequency increases.

This rule identifies new protocols and combinations of protocol and destination port. New protocols generate warning or critical alarms and may trigger an investigation by the operator. During the investigation, the protocol remains in NEWPROTOCOLS. At some point after the investigation ,the protocol is moved to KNOWNPROTOCOLS. If a new destination alarm has been generated (with a known protocol) an advisory alarm is generated and the operator will add DESTNETWORK to KNOWNDESTINATIONS. PACKETPROTOCOLID trend alarms may be advisory, warning or critical based on the amount of slope change or the threshold level exceeded. For PACKETPROTOCOLID alarms, the operator qualifies the trend as normal or suspicious and resets thresholds.

Rule 6—Update Deficiency Risk Probability (445)

This rule monitors when intrusion detection system systems are updated and configured and generate increasingly higher priority alarms the longer the network intrusion detection system system goes without an update. Because attacks evolve and new attacks are created constantly, the probability of compromise goes up over time if appropriate countermeasures are not taken. This rule is similar to the Neglected Firewall Rule from the Firewall Guidelines, in that it does not monitor characteristics of the information that is being filtered, but rather describes characteristics of the filtering itself.

Parameters

| Parameter | Description |
|---|---|
| NIDSID | The network intrusion detection system |
| | ID |
| UPDATEFREQ | A time period to measure anticipated |
| | updates for the network intrusion |
| | detection system (start monthly) |
| NOD(NIDSID)_UPDATE | The timestamp for the latest update to |
| | the NIDS |
| UDRP | The update risk probability factor |
| UDRPTHRESHOLD_[123] | A threshold for alarm criticality (set |
| | three 0.5, 0.75, 0.9) |

RUN ROUTINE DAILY
FOR ALL NIDSID
UDRP = (CURRENT TIME-NOD(NIDSID)_UPDATE/UPDATEFREQ
FOR N IN {3,2,1}

IF UDRP > UDPRTHRESHOLD_N

ALARM “UDRP THRESHOLD EXCEEDED” EXIT

Rule 7—Specific Targeting (450)

This rule analyzes attacks in order to determine if specific hosts are being targeted. When a specific host on the network receives one attack or a series of attacks at low frequency, this could signal that careful reconnaissance is in progress. Better planned attacks are more likely to be successful. Highly skilled hackers prepare and refine exploits prior to attacking the ultimate target.

This rule examines the targets of attacks and alarms when only specific hosts are being targeted in a specific network zone.

| Parameter | Description |
|---|---|
| TARGETZONE | A collection of systems, typically |
| | a network |
| TARGETZONEID | A unique identifier for the |
| | TARGETZONE |
| TARGETIP_{—} | A running counter (See Attack |
| VULNERABELATTACKS_{—} | Sequence Target Qualification rule) |
| COUNT | |
| TARGETIP_{—} | A running counter (See Attack |
| HARMLESSATTACKS | Sequence Target Qualification rule) |

RUN ROUTINE PERIODICALLY(120 SEC TO 1 HOUR)
FOR EACH TARGETZONE

FOR EACH IP ADDRESS

PLOT TARGETIP_VULNERABLEATTACKS_COUNT
PLOT TARGETIP_HARMLESSATTACKS_COUNT
PLOT SUM OF ABOVE

ANALYZE PLOT FOR DISTINGUISHABLE PEAKS THAT
INDICATE SPECIFIC TARGET

ALARM “IP ADDRESS ATTACK AGGREGATION”

Slope changes for plot from one IP address to the next indicates that the second IP address has had more attacks. Slope change indicates criticality. Once a slope change is identified, thresholds can also be applied to refine criticality. Deviation from mean can also be used.

A TARGETZONE is a collection of systems used for the Specific Targeting rule in order to quantify and compare attacks. The network can be divided into a series of target zones based on the security level of the network, IP address, netmask and routing visibility. The sum of all TARGETZONEs will equal the total network. A subnetwork (e.g. a class C network) should be considered the first factor in defining a TARGETZONE although the zone may span several subnetworks. All IP addresses in a TARGETZONE are “visible” to each other in that they are on the same broadcast domain or there is a network path (a route) between them. Firewalls and router access control lists partition the total network into TARGETZONES. For each network intrusion detection system in the network the TARGETZONE that it is part of would also be defined by NSM(NIDSID)_ACCSEGMENT (See Attack Sequence Target Qualification rule).

Rule 8—Target Type/Attack Type Association (455)

This rule compares the attack specific information with qualities of the target and alarms only when the attack is “compatible” with the attack. This rule filters out all attacks that are launched against hosts that are invulnerable to the attack. This rule is dependent on Rule 3, Attack Sequence Qualification.

Parameters

| Parameters | Description |
|---|---|
| ATTACK_NAME | The name of the attack (see |
| | for Common Vulnerabilities |
| | and Exposures) |
| TARGETIP | The IP address of the target |
| | system |
| NOD(TARGETIP) | The Network Objects Database |
| | Entry for the target IP |
| OSVERSION | The OS version of the target |
| | IP system |
| APPVERSION | The application version of the |
| | target IP system |
| VULNERABLEATTACKS | Counter ID for vulnerable attacks |
| HARMLESSATTACKS | Counter ID for harmless attacks |

CONTINUE FROM PREVIOUS PROCESSING
IF ATTACK MESSAGE RECEIVED
IF KAD(ATTACK_NAME)_AFFECTEDSYSTEMS=
NOD(TARGETIP)_OSVERSION

TARGETIP_VULNERABLEATTACKS_COUNT++
ALARM “TARGET OS SYSTEM VULNERABLE” EXIT

IF KAD(ATTACK_NAME)_AFFECTEDSYSTEMS=
NOD(TARGETIP)_APPVERSION

TARGETIP_VULNERABLEATTACKS_COUNT++
ALARM “TARGET APPLICATION VULNERABLE” EXIT

NOTE: “=” MEANS VULNERABLE, THIS MIGHT BE
VERSION <VULNERABLE_VERSION OR VERSION !=
INVULNERABLE_VERSION.
TARGETIP_HARMLESSATTACKS_COUNT++
TREND(TARGETIP_VULNERABLEATTACKS_COUNT.
TARGETIP_HARMLESSATTACKS_COUNT)

Rule 9—“HIDS/NIDS Delta Alert on Target” (465)

This rule is a multi-security device class correlation rule. This alarm is created when both: a) an attack is detected against a target by the Network Based Intrusion Detection System (NIDS) and b) shortly thereafter a Host Based Intrusion System (HIDS) alarm is generated. This rule is dependent on HIDS event normalization and collection. The two successive intrusion detection system messages combined constitute an alarm that is much more important than either alarm in isolation.

Parameters

| Parameter | Description |
|---|---|
| ATTACK_NAME_NIDS | The name of the attack (see for Common |
| | Vulnerabilities and Exposures) |
| ATTACK_NAME_HIDS | The name of the attack (see for Common |
| | Vulnerabilities and Exposures) |
| NIDSID | The network intrusion detection system ID |
| HIDSID | The HIDS ID |
| TARGETIP | The IP address of the target system |
| HIDSNIDSTIMER | A timer |

CONTINUE FROM PREVIOUS PROCESSING
IF ATTACK MESSAGE NETWORK INTRUSION DETECTION
SYSTEM RECEIVED AND ALARM
GENERATED
TARGETIP_ATTACKNAME_NIDS_HIDSNIDSTIMER START
EXIT
CONTINUE FROM PREVIOUS PROCESSING
IF ATTACK MESSAGE HIDS RECEIVED

IF TARGETIP_ATTACKNAME_NIDS_HIDSNIDSTIMER
NOT EXCEEDED
ALARM “NETWORK ATTACK HOST CHANGE”

RUN PERIODICALLY(120 SEC TO 60 MINUTE)
FOR ALL TARGETIP

IF TARGTIP_ATTACKNAME_NIDS_HIDSNIDSTIMER
EXCEEDED

TARGETIP_ATTACKNAME_NIDS_HIDSNIDSTIMER
STOP RESET

This alarm consolidates the HIDS and the network intrusion detection system alarm consoles The alarm will help the operator avoid a separate check of the HIDS. If the network intrusion detection system identifies an attack, the operator can proceed to investigate it with one fewer steps (checking the HIDS).

Rule 10—Scan Type Partition and Scheduling (460)

This rule correlates scan attack data in order to determine how scans are being conducted on the network. Network scans are used to gain information about hosts and networks. Scanning a host allows a would-be attacker to determine the operating system and version and the applications running on the host. Scans are also used to map network topography. By collecting and trending scan attack information it is possible to determine which scans are conducted with more stealth. This is important on the internal network and on segments visible to the Internet.

| Parameter | Description |
|---|---|
| ATTACK_NAME | The name of the attack (see |
| | www.mitre.org for Common |
| | Vulnerabilities and Exposures) |
| | Scan Attacks |
| TARGETIP | The IP address of the target system |
| SRCIP | The source IP of the packet (Scan) |
| SCANSLOTS | An array of ports or sub-IP scan |
| | destinations |
| SCANFREQUENCY | The frequency of received scan packets |
| SCANDURATION | The duration of the scan (reset |
| | periodically) |
| SCANSTART | The start time of the scan |
| LASTSCANPACKET | The timestamp of the last scan packet in |
| | an ongoing scan |
| COUNT | A running counter |
| SCANTYPES | A scan type bitmap or list to track |
| | the number of different scans the |
| | source has launched (TCP_CONNECT, |
| | TCP SYN, TCP FIN, TCP FTP |
| | PROXY, SYN/FIN, UDP, UDP raw, |
| | ICMP, Reverse indent) see |
| | www.insecure.org |
| SCANNERS | An array of scanning IP addresses with |
| | information about scan (historical) |

CONTINUE FROM PREVIOUS PROCESSING
IF ATTACK MESSAGE SCAN RECEIVED
IF TARGETIP_SRCIP_ATTACK_NAME_SCANSTART
NOT SET

TARGETIP_SRCIP_ATTACK_NAME_SCANSTART =
TIMESTAMP

TARGETIP_SRCIP_ATTACK_NAME_COUNT++
IF TARGETIP_SRCIP_SCANTYPES NOT SET

SET TARGETIP_SRCIP_SCANTYPES FOR
ATTACK_NAME

PARSE ATTACK_NAME_PORT INTO TARGETIP_SRCIP_{—}
ATTACK_NAME_SCANSLOTS
COMPUTE TARGETIP_SRCIP_ATTACK_NAME_{—}
SCANFREQUENCY (*COUNT/*DURATION)
ANALYZE TARGETIP_SRCIP_ATTACK_NAME_SCANSLOTS

IS THERE AN EVEN DISTRIBUTION?
(RANDOMLY SCANNING ALL PORTS)
IS THE SCAN ONGOING AND SEQUENTIAL?

ANALYZE SCANTYPES

DOES SCANTYPES INDICATE MULTIPE SCAN TYPES?

CATEGORIZE SCANFREQUENCY

<1 SEC
<1 MINUTE
<1 HOUR
<24 HOUR

CLEAN UP ROUTINE(RUN PERIODICALLY 12 OR 24 HOUR)

RESET DURATION AND FREQUENCY
MOVE SRCIP TO SCANNERS IF SCAN TIMES-OUT

SCANSLOTS is an arbitrary parameter used to partition the possible scan address space of each target. For example a SCANSLOT might be 1000 or 500 ports. A scan slot might be 1 port (a bit map recommended if the scan slot is this granular). A stealthy scanner will slow scan in order to have the scan remain unnoticed as the single low frequency scan packets fade into normal traffic. By using scan slots graph, analysis can be done in order to determine the distribution of scan destinations. Scan destinations can be combined with scan frequencies to generate alarms or additional intelligence in informational pop-up windows when other alarms are generated.

Rule 11—Attack with Precursor Scan (470)

This rule alarms on attacks that originate from networks that have previously been scanning the target network. Assuming that the attack is compatible with the target, attacking networks that scan prior to attacking display an added level of sophistication.

Parameters

| Parameter | Description |
|---|---|
| ATTACK_NAME | The name of the attack (see www.mitre.org) |
| | for Common Vulnerabilities and Exposures) |
| SRCIP | The source IP of the packet (Scan) |
| TARGETIP | The IP address of the target system |
| SCANNERS | An array of scanning IP addresses with |
| | information about scan (historical) |
| SCANDURATION | The duration of the scan (reset |
| | periodically) |

CONTINUE FROM PREVIOUS PROCESSING
IF ATTACK MESSAGE RECEIVED
IF ATTACK IS A SCAN EXIT
IF SRCIP IN TARGETIP_SRCIP_ATTACK_NAME_{—}
SCANNERS AND

TARGETIP_SRCIP_ATTACK_NAME_{—}
SCANDURATION !=0

ALARM “ATTACK FOLLOWED SCAN”

Rules 12-17 are network intrusion detection system specific versions of rules described above, in the firewall rule section, and are not described in detail herein.

### Authentication, VPN and Host Intrusion

Special rules are also defined for operations that can uniquely be carried out within the network. These include authentication, virtual private networking, and host intrusion detection.

Authentication is the process of identifying an individual or system. As users and systems communicate with each other on the network, they accept or reject data based on whether or not the system they are communicating with can identify themselves with some degree of certainty. authentication can be strong, weak or implied, depending on the value or classification of the data being exchanged. Stronger the authentication provides greater certainty that the individual or system is what they identify themselves to be. Conversely, implied authentication is when no authentication is required to access the service. The service is available if you can connect to it, like a typical web site home page.

Authentication involves the exchange of a shared secret, the possession of a device (token), the exchange of unique information or some combination of all three. Authentication systems are implemented with Authentication Servers, protocols and client agents.

Authentication systems centralize the task of identifying users on the network. Application servers and the services that the applications provide vary widely in terms of their geographic distribution and application protocols that they use. As systems and services are developed and deployed on the network, the problem of maintaining the user credential database in a distributed environment becomes complicated. Each system has its own database which makes maintenance and synchronization more difficult. Although the databases are different, typically they have the same secrets in them so that users would not have to memorize a different secret for every system. This results in reduced security because of the difficulty in securing all the credential databases.

Authentication servers (AS) support a distributed authentication architecture where the user authenticates to the AS and is then granted access to a service. The service can be “access to the network” or an application service on the network. When the user attempts to connect to the access device or application service, the receiving device communicates with the AS or defers the user to the AS to perform authentication.

Authentication servers are used for many applications including network access, workstation access and application access.

Once a user is authenticated, that user is then authorized to access a device, service or network. Authorization is dependent upon authentication. By implementing access controls based on authentication, various levels of access can be granted on an application specific or network basis.

One example of authorization includes users who are permitted to run different, successively larger sets of commands on a system based on their role on the system. Users might have access to only a small set of application commands. Operators might have access to additional application maintenance and monitoring commands. Administrators might have access to user, operator and application reconfiguration commands (e.g. application stop and start).

Accounting is the process of tracking authentication and authorization. Authentication systems frequently support accounting. As the user authenticates and uses system resources (through explicit or implicit authorization), the systems send accounting messages to the accounting server. This is frequently used for network access services where the time spent connected to the network is the basis for fees and service charges. The accounting functions of the AS may be a rich source for security related events from authentication systems.

Servers or applications that implement, enforce and manage authentication, authorization and accounting are referred to as AAA servers. Two popular protocols for AAA include Remote Access Dial In User Service or RADIUS and Lightweight Directory Access Protocol or LDAP. Another frequently used protocol is Terminal Access Controller Access Control System or TACACS (all variants) by Cisco Systems. This latter protocol is typically only used for router and switch administrative access.

The packet aggregate on the network can be viewed as a collection of overlapped intertwining sessions, some of which are authenticated, some are not and some actual authentication sessions in progress. By aggregating, normalizing and processing the accounting messages from the AAA server, the security infrastructure management system can qualify connections implicated by other elements.

A Virtual Private Network (VPN) is a connection that uses encryption to prevent the information passing across the connection from being disclosed at intervening network nodes. The information in a VPN is encrypted only at each end of the connection. In this way, information classified as “not for public consumption” can pass through network routes on public or less classified networks such as the Internet. A VPN 121 is shown in FIG. 1.

The encrypted connection is sometimes referred to as an encrypted tunnel, and is shown as a tunnel in FIG. 1. Virtual Private Networks are implemented in two broad categories, client-to-gateway and gateway-to-gateway.

A client-to-gateway (client) VPN encrypts and decrypts information between the client workstation computer and a network node called the VPN gateway. As the data passes the gateway from the client it is decrypted and traverses the network beyond the gateway unencrypted. As information passes back to the client it is encrypted at the gateway and then passed to the client. The client encrypts or does not encrypt based on the destination of the packets. Connections to systems that are not “beyond the VPN gateway” are passed directly from the client and are not encrypted. Client VPNs are typically used to give remote workers, clients or partners access to a corporate network across the Internet and are typically implemented at or on a firewall. Client-to-gateway VPNs are among the most common type of VPN.

A gateway-to-gateway (gateway) VPN encrypts and decrypts information between two special network nodes (the gateways). The VPN gateways are routers that encrypt and decrypt all packets transferred between them. Gateway VPNs are typically used when the number of persons or systems communicating is large enough to make client-to-gateway VPNs infeasible. Gateway VPNs implement encrypted “extranets” that traverse public networks.

Data passing across VPNs is by definition encrypted and difficult to inspect while it is in the encrypted tunnel. The messages generated by VPN devices are primarily concerned with operational telemetry between the clients and gateways. Client VPNs typically serve as enterprise network access authentication points for remote workers and therefore generate network access messages. The encryption schemes used in VPNs are complicated and require frequent key exchanges and control signaling. In general, the messages generated by VPNs are related to the proper operation of the VPN and traffic statistics.

As a part of the security infrastructure, VPN devices act like routers that authenticate users or other routers and encrypt data between network nodes. The security infrastructure management system can centralize the monitoring function of VPNs and generate alarms based on authentication success, client location and VPN traffic anomalies.

Host Based Intrusion Detection Systems (HIDS) perform a role similar to that of Network Intrusion Detection Systems (NIDS). Where the network intrusion detection system is concerned with monitoring network segments and therefore detects attacks affecting multiple hosts, HIDS is a concerned only with the host upon which it is installed. The functions of the HIDS may overlap those of the network intrusion detection system in the disclosed embodiment. For example, both network intrusion detection system and HIDS may detect changes in the host software or application software running on the host. A HIDS can also perform the same network based attack signature detection as network intrusion detection system by examining packets processed by the local IP stack(s).

HIDS also provides distinct functionality. The HIDS monitors system logs, the state of program files and program execution locally. If an exploit is executed against a system, the resulting change of file-system state or change of process execution on the target system can be detectable. If an exploit is successful but not detected, then the activities of the intruder on the system can be detected by HIDS as they run atypical programs or change the contents of files. The concept of system integrity defines the contents of all operating system and application files as a known trusted state.

HIDS periodically checks the contents and attributes of all “critical” system files. As program files change, because they were replaced or modified by an intruder or malicious user, the HIDS system detects the change and generates an alarm. Host based intrusion detection systems originated from simple automated file integrity checking programs.

The security infrastructure management system can aggregate, analyze and trend messages and alarms from host based intrusion detection systems to generate enterprise level intelligence. This multi host perspective can enhance the ability of administrators to detect successful or potentially successful attacks on the network infrastructure and network hosts.

Network Address Translation (NAT) is carried out by router 101 accepting a connection from one interface, changing the source IP address to a translated address (the NAT address) and forwarding the packet to another interface. The router then maintains the state of all connections from the original source IP address maintaining the translation. As packets traverse the router, it automatically translates the source and destination addresses of the connections so that they reach the original source IP address.

NAT allows networks to allocate large numbers of private IP addresses within the network, and a small number of visible “NATed” addresses. NAT, however, may mask the original IP address, making it difficult to find out adequate information about the attack. In this embodiment, NAT information may be logged, to preserve the information

The User Authentication Rules are described herein. These rules rely on a message stream coming from the authentication server. The architectures and messaging mechanisms of the different authentication protocols vary widely. These rules support alarming and intelligence gathering from messages that are generic to authentication servers and for many different authentication systems.

| Rule | Description |
|---|---|
| 1 | Network Authentication Monitor |
| 2 | Authenticated Attack/Anomaly |
| 3 | User Geographic Anomaly |

Virtual Private Network Device Rules

These rule support alarming and intelligence gathering on VPN devices and software agents.

| Rule | Description |
|---|---|
| 1 | VPN Attack Source |
| 2 | Key Exchange Frequency Deviation |
| 3 | VPN Payload Ramp |

Host Based Intrusion Detection Rules

The HIDS rules cover those messages that can generate alarms and intelligence that are uniquely HIDS in origin. The network intrusion detection system based rules can also be modified to become HIDS rules.

| Rule | Description |
|---|---|
| 1 | New Attack/Anomalous Behavior |
| 2 | Multi Host Correlation |
| 3 | Authentication Monitor |

General Rules

These rules are general rules that are applicable to all security device classes. They are present here in a roll up manner.

| Rule | Description |
|---|---|
| 1 | Pass Through/HT Console |
| 2 | Update Deficiency |

User Authentication Rule 1—Network Authentication Monitor (505)

Authentication servers permit or deny access to the network, network hosts or applications. Each authentication request is either accepted or rejected. Rejected authentication requests are monitored. This can detect attempts to brute force the network. By monitoring accepted authentication requests, the originating IP address can be associated with a userid and used later when the IP address is implicated by events from other security devices.

This rule creates authentication logs and compares them with the session timeout associated with each authentication. Because session timeouts vary, an entry in the Network Objects Database (see network intrusion detection system rules) provide the session timeout information.

Parameters

| Parameter | Description |
|---|---|
| ASID | Authentication Server |
| | Identification Number (IP address |
| | or Domain names) |
| USERID | A string that identifies a user |
| AUTHIP | The IP address the AS is |
| | authenticating |
| AS_EVENT_TIME | The time of the authentication |
| | event |
| NOD (ASID) | The Network Objects Database entry |
| | for the authentication server. |
| | This contains authentication |
| | parameters |
| AUTHSUCCESS | Boolean - indicates the success or |
| | failure of the authentication |
| FAILCOUNT | A running counter of failed |
| | attempts |
| AUTHENTICATED [ ] | An array or linked list of |
| | authentication entries maintained |
| | by HTS |
| TIMESTAMP | A time stamp |
| FAILATTEMPTHRESHOLD | The number of times an |
| | authentication can fail before |
| | generating an alarm |

IF AUTHENTICATION MESSAGE RECEIVED
IF AUTHSUCCESS

AUTHENTICATED_ASID_USERID_TIMESTAMP =
AS_EVENT_TIME
AUTHENTICATED_ASID_AUTHIP_TIMESTAMP =
AS_EVENT_TIME

ELSE

ASID_USERNAME_FAILCOUNT++
ASID_AUTHIP_FAILCOUNT++
IF ASID_USERID_FAILCOUNT >
FAILATTEMPTHRESHOLD

ALARM “USERID FAILED AUTHENTICATION
THRESHOLD EXCEEDED”

IF ASID_AUTHIP_FAILCOUNT >
FAILATTEMPTHRESHOLD

ALARM “AUTHIP FAILED AUTHENTICATION
THRESHOLD EXCEEDED”

CONTINUE PROCESSING
IF USERID QUERY REQUESTED BY OPERATOR

DISPLAY MATCHING USERIDs FROM

AUTHENTICATED_ASID_USERID_TIMESTAMP[ ]
IF AUTHIP QUERY REQUESTED BY OPERATOR

DISPLAY MATCHING AUTHIP FROM
AUTHENTICATED_ASID_AUTHIP_TIMESTAMP[ ]

NOTE: CAN BE DONE WITH TIME BRACKETING
CONTINUE PROCESSING

Authentication Rule 2—Authenticated Attack/Anomaly (510)

Building on Authentication Rule 1, when attacks are detected by HIDS or NIDS, the list of currently authenticated IP addresses can be referenced to determine if a recent authentication attempt succeeded or failed. additional information about the identity of the attacker can be collected by correlating the combinations of events. A determination of whether the source IP is in the list of previously authenticated IP addresses can be useful when investigating an attack.

Parameters

| Parameter | Description |
|---|---|
| ASID | Authentication Server |
| | Identification Number (IP address |
| | or Domain names) |
| USERID | A string that identifies a user |
| AUTHIP | The IP address the AS is |
| | authenticating |
| SRCIP | Source IP of an attack |
| AUTHENTICATED [ ] | An array or linked list of |
| | authentication entries maintained |
| | by HTS |
| NOD (ASID) | The Network Objects Database entry |
| | for the authentication server. |
| | This contains authentication |
| | parameters |
| TIMESTAMP | A time stamp |
| SESSIONTIME | The timeframe over which the |
| | authentication is valid |

IF ATTACK MESSAGE RECEIVED FROM HIDS/NIDS/FIREWALL
FOR ALL ASID

IF SRCIP IN AUTHENTICATED_ASID_AUTHID

IF CURRENTTIME − AUTHENTICATED_ASID_{—}
AUTHID_TIMESTAMP <

NOD(ASID)_SESSIONTIME

ALARM “AUTHENTICATE IP ADDRESS
ATTACKING”

NOTE: QUICKEST ACCESS TO RECORDS NOT DETERMINED
IF SRCIP OF ATTACK IN ASID_AUTHENTICATED_AUTHIP
DISPLAY AUTHENTICATION HISTORY OF AUTHIP
WITH USERIDs

Authentication Rule 3—Duplicate Authentication/Geographic Anomaly (515)

Each authentication request causes a userid to be passed to the authentication server. An authentication request for a particular service should not have a userid that is already authenticated to that service. Moreover, authentication requests for the same userid should not vary geographically over a short time period.

This rule analyze all currently authenticated userids with respect to service and the originating location of the authentication request to determine anomalies which may indicate a compromised user id being used by multiple sources.

Parameters

| Parameter | Description |
|---|---|
| ASID | Authentication Server |
| | Identification Number (IP address |
| | or Domain names) |
| USERID | A string that identifies a user |
| AUTHIP | The IP address the AS is |
| | authenticating |
| AS_EVENT_TIME | The time of the authentication |
| | event |
| NOD (ASID) | The Network Objects Database entry |
| | for the authentication server. |
| | This contains authentication |
| | parameters |
| AUTHSUCCESS | Boolean - indicates the success or |
| | failure of the authentication |
| AUTHENTICATED [ ] | An array or linked list of |
| | authentication entries maintained |
| | by HTS |
| SESSIONTIME | The timeframe over which the |
| | authentication is valid |
| GTIME | A time period over which a |
| | geographically diverse set of |
| | authentication events is suspicious |

IF AUTHENTICATION MESSAGE RECEIVED
IF AUTHSUCCESS

IF AUTHIP IN AUTHENTICATED[ ] AND ASID_AUTHIP_{—}
SESSIONTIME NOT

EXCEEDED

ALARM “MULTIPLE AUTHENTICATION FROM IP”

IF USERID IN ATHENTICATED[ ] AND ASID_USERID_{—}
SESSIONTIME NOT

EXCEEDED
ALARM “MULTIPLE AUTHENTICATION FROM USERID”

EVALUATE USERID FOR GEOGRAPHIC DISTRIBUTION
IF USERID AUTHENTICATED FROM GEOGRAPHICALLY
DIVERSE LOCATIONS IN < GTIME

ALARM “GEOGRAPHIC ANOMALY FOR USERID
Note: Session termination messages are also generated by the AS and should be considered in the pseudo code above. It is assumed above the “user logged out” messages were not received.

This rule evalutes IP addresses based on their geographic dispersion. This is similar to The Connection Path concept described herein, in the Correlation Section. Routing analysis may be used to assign a probability measure to the geographic diversity between two IP addresses. A background process can constantly monitor networks and determine trunks and domains that traverse geographic areas. Traceroute can then be used to assess the path to each IP address and be compared with known geographic gateways.

If a userid has been authenticated multiple times, then there is a possibility that multiple individuals are using the same userid. Userid sharing is a violation of the typical security policy and the alarm should be at the warning level. Geographic anomaly alarms are critical. When these alarms are received, the operator should log the alarm; userid and IP address information and generate an email to a contact “userid email or manager email” indicating an authentication violation has taken place.

Virtual Private Network Rule 1—VPN Attack Source (520)

As attack alarms are received by the security infrastructure management system, each attack is evaluated to determine if it originated from a VPN. A connection originating from a VPN is assumed to be from a source with a higher level of trust than the Internet. Attacks launched from a trusted source have the potential to be more damaging. A trusted source may have more intelligence on the system being attacked, and therefore may be more successful.

Parameters

| Parameter | Description |
|---|---|
| VPNID | VPN gateway identifier |
| ADDRESSPOOL | An IP or pool of IP addresses used |
| | by the gateway to |

IF ATTACK MESSAGE RECEIVED FROM HIDS/NIDS/FIREWALL
FOR ALL VPNID

IF ATTACK SRCIP IN VPN_ADDRESSPOOL

ALARM “ATTACK THROUGH VPN”

This alarm augments other alarms and may be displayed as a qualifier to those alarms. A “VPN SOURCED” message can be part of the alarm messages generated by other devices.

Virtual Private Network Rule 2—Key Exchange Frequency Deviation (525)

VPNs exchange keys used by the encryption algorithms that implement the security of the VPN. The VPN typically sends a message when the keys are exchanged. Analysis of the key exchange frequency allows identification of anomalies that represent potential attack activities.

Parameters

| Parameter | Description |
|---|---|
| VPNID | VPN gateway identifier |
| VCLIENTID | VPN client identifier |
| KEYEXFREQUENCY | Frequency computed in real time |
| TIMESTAMP | A timestamp on the event |
| DELTA | A measurement of slope change |
| | considered significant for key |
| | exchange frequency |

IF KEY EXCHANGE MESSAGE RECEIVED
COMPUTE VPNID_VCLIENTID_KEYEXFREQUENCY
PLOT VPNID_VCLIENTID_KEYEXFREQUENCY
PERIODICALLY

FOR EACH VPNID

FOR EACH VLCIENTID
EVALUATE VPNID_VCLIENTID_KEYEXFREQUENCY

IF SLOPE CHANGE > DELTA

ALARM “VPNID_VCLIENTID FREQUENCY
CHANGE EXCEEDED

VPN gateways and clients only exchange keys while they are connected. Between VPN “sessions”, no keys will be exchanged. An observation that the frequency of key exchange has reduced dramatically signals that the client and gateway are not connected.

The rule is primarily concerned with excessive positive changes in key exchange frequency. When a session starts there will be one abrupt change between the first and second key exchanges. Therefore, the Evaluate section may consider only the time between VPN start and VPN stop messages as the contiguous plot to analyze. This is a discrete switching plot.

Virtual Private Network Rule 3—VPN Payload Ramp (530)

VPNs are used to bridge the corporate network with remote “trusted” networks. Monitoring and trending the payload of individual VPN connections makes it possible to determine an alarm based on significant deviations from these patterns. The aggregate payload magnitude, and the time distribution can both be used to detect the movement of data to and from the corporate network

Parameters

| Parameter | Description |
|---|---|
| VPNID | VPN gateway identifier |
| VCLIENTID | VPN client identifier |
| TX | The number of packets transmitted |
| | “out” of the trusted network |
| RX | The number of packets received |
| | “into” the trusted network |
| TXRANGE | An acceptable TX payload range for |
| | the VPN |
| RXRANGE | An acceptable RX payload range for |
| | the VPN |

PERIODICALLY(NOT TO EXCEED 3 HOURS)
FOR EACH VPNID

FOR EACH VCLIENTID
PLOT VPNID_VCLIENTID_TX
PLOT VPNID_VCLIENTID_RX
NOTE: VCLIENTID CAN BE THE GATEWAY VPNID ON
THE FAR SIDE OF A GATEWAY-TO-

GATEWAY VPN

EVALUATE VPNID_VCLIENTID_TX

IF VPNID_VCLIENTID_TX OUTSIDE OF
VPNID_VCLIENTID_TXRANGE

ALARM “VPNID_VCLIENTID TX RANGE
EXCEEDED”

EVALUATE VPNID_VCLIENTID_RX

IF VPNID_VCLIENTID_RX OUTSIDE OF
VPNID_VCLIENTID_RXRANGE

ALARM “VPNID_VCLIENTID RX RANGE
EXCEEDED

Large sums of data leaving the network over the VPN prior to a pending layoff is more critical than a slight increase in traffic during a quarter end or just prior to a product release. This alarm is best analyzed taking into account the nature of the VPN.

Host Based Intrusion Detection Rule 1—New Attack/Anomalous Behavior (540)

This rule compares information from attack or anomalous behavior message from the HIDS system against information contained in the Known Attacks Database (see network intrusion detection system rules above). This rule is similar to network intrusion detection system Rule 1 Attack Count and Profiling. However, certain parts of such attacks are uniquely detectable by HIDS. HIDS detects file integrity changes that cause alarms that are not “attack specific.” Therefore this rule will have less specific HIDS message data in place of the ATTACK_NAME field in network intrusion detection system Rule 1.

Since the HIDS is detecting this type of anomaly on the system itself, there is no need to correlate or alarm based on the vulnerability of the operating system or application.

For HIDS alarms of this type, the Known Attacks Database (KAD) and Detected Attacks Database (DAD) use a series of message content hashes (parsing) instead of known attack names as in the Common Vulnerabilities and Exposures.

Parameters

| Parameter | Description |
|---|---|
| HIDSID | An identifier for the HIDS |
| ATTACK_MESSAGE | This will be text from the HIDS |
| | indicating which files were |
| | modified or system anomalies were |
| | detected (should be hashed for |
| | content) |
| HASH ( ) | A parsing function that extracts |
| | content from ATTACK_MESSAGE so that |
| | messages from multiple sources can |
| | be compared. |
| HIDSEVENTTIME | The time of the event |
| HIDMSGINSTANCE | A normalized, time-stamped instance |
| | of the HIDS message, a HIDS KAD/DAD |
| | entry |
| NEW | Boolean, An attack is new if it is |
| | not in the detected attacks |
| | database. An attack remains “new” |
| | until it is manually changed by the |
| | operator to a known status |
| HISTORICAL_TARGETS | Array of target IP/Network |
| | Addresses |

IF HIDS FILE INTEGRITY OR PROCESS ANOMALY MESSAGE
RECEIVED
HIDSMSGINSTANCE = HIDSID_HIDSEVENTTIME_{—}
HASH(ATTACK_MESSAGE)
FOR HASHMSGINSTANCE
IF HASH(ATTACK_MESSAGE) NOT IN KNOWN ATTACK
DATABASE(KAD)

SET HIDSMSGINSTANCE_NEW = TRUE
ALARM “ NEW HIDS MESSAGE OPERATOR POPULATE DAD,
KAD, ANALYZE” EXIT
PROCESSING

IF HASH(ATTACK_MESSAGE) NOT IN DETECTED ATTACKS
DATABASE(DAD)

CREATE RECORD OF THE ATTACK IN DETECTED
ATTACK DATABASE
POPULATE DAD FROM KAD

HASH(ATTACK_MESSAGE)_COUNT++
IF HIDSID NOT IN HISTORICAL_TARGETS

ADD HIDSID TO HASH(ATTACK_MESSAGE)_HISTORICAL_{—}
TARGETS

HASH(ATTACK_MESSAGE)_HIDSID_COUNT++
CONTINUE
Note: The HIDS message will now pass through other rules

The goal of hashing the message contents is to attain a computer comparable content of the message that is logically related to the function or feature of the HIDS. Some examples of messages and suitable hashes are:

| Message | Hash |
|---|---|
| File /etc/password | File Change, |
| has changed on | /etc/password, |
| mail.hightower.com | mail.hightower.com |
| Process | Execution Anomaly, |
| /var/bin/lpd | /var/bin/lpd, |
| stopped | printserver.information |
| unexpectedly on | smith.com |
| printserver.informa | |
| tionsmith.com | |

Host Based Intrusion Detection Rule 2—Multi Host Correlation (545)

As each attack or anomalous behavior is reported by the HIDS system, the number of systems experiencing the same phenomenon can be tracked. As attacks or anomalous behaviors are detected an alarm can be generated with a criticality proportional to the number of systems reporting the attack in a period of time. This alarm is an epidemiological measure of specific HIDS alarms for a period.

Parameters

| Parameter | Description |
|---|---|
| HIDSID | An identifier for the HIDS |
| ATTACK_MESSAGE | This will be text from the HIDS |
| | indicating which files were |
| | modified or system anomalies were |
| | detected (should be hashed for |
| | content) |
| HASH( ) | A hashing function that extracts |
| | content from ATTACK_MESSAGE so that |
| | messages from multiple sources can |
| | be compared. |
| HIDSEVENTTIME | The time of the event |
| NEW | Boolean, An attack is new if it is |
| | not in the detected attacks |
| | database. An attack remains “new” |
| | until it is manually changed by the |
| | operator to a known status |
| INFECTIONPERIOD | A period of time over which |
| | multiple HIDS messages from |
| | different hosts would be suspicious |
| HISTORICAL_TARGETS | Array of target IP/Network |
| | Addresses |

If HIDS File Integrity or Process Anomaly message received
For all HIDSID

If HIDS messages of the same or similar hashes have

occurred in INFECTIONPERIOD

Alarm “Multi Hosts Experiencing

HASH(ATTACK_MESSAGE)”

The criticality of this alarm is based on the number of hosts experiencing the same anomaly.

Host Based Intrusion Detection Rule 3—Authentication Monitor (550)

Each HIDS monitors and sends messages as local authentication takes place on the host system. By monitoring the userid of the person authenticating, valuable information can be stored and combined with other alarms. This is a special instance of A Priori log recall but specifically for local authentication information. When a HIDS message indicates the state of the file system or the processing on a system has changed, it will usually mean that a user or administrator is working on the system.

Administrative authentication events on all systems should generate an alarm. When the alarm is received, the operator should verify that there is a scheduled maintenance activity occurring on the system. If not then an investigation needs to be started. When responding to other alarms, the status of authenticated users on the system is helpful to the investigator. This can be presented in an informational window on request or used to augment other host specific alarm displays. This rule will alarm on failed authentication attempts and provide the real time parameters for displaying currently authenticated users on a system.

General Rule—1 Pass Through Alarming

This method is passed through all configured alarms for the device.

General Rule—2 Update D fici ncy Risk

This rule was first described in phase 2 of this project, Network Intrusion Detection System Guidelines. All devices that make up the security infrastructure will be contribute positively to the probability of successful attacks against the network the longer they are not updated.

### Correlation

The above rules described faults which should be monitored. However, another important aspect of the monitoring of these faults is correlating the different faults to one another. For example, while the network intrusion detection systems detect known attacks, unknown attacks may pass through these conventional detection systems.

The rules noted above, as well as other more conventional firewall rules, typically generate large quantities of log data. A security administrator often reviews the log data in an attempt to detect attacks. This detection may include an identification of the target of the attacks, the property of the attacks, and the source of the attacks. Tying may be crucial during an attack, and the length of time that it takes the administrator to answer the questions may mean the difference between loss or destruction, or effective avoidance of the attacks. Moreover, the administrator must access large quantities of information from many different disparate systems.

The paradigm described herein teaches a correlation architecture which monitors security events from a number of different classes, aggregates these data, and identifies anomalies in the data. The data being analyzed may include network mapping tools that maintain the network segment map structure, network sensors, network vulnerability scanning tools, and dynamic host control protocol (DHCP) server logs. The network sensor may be especially crucial, to detect future ways in which similar offense can be avoided.

Correlation Rules

The correlation rules presented below constitute a series of rules, methods of functions to be performed by a security infrastructure management system. The rules describe the high level logic and structures that can be used to gain extra intelligence from the aggregate event stream. These rules define ways of presenting information that aid the operator in investigating security incidents, by aggregating and presenting information in a superior way.

The rules are summarized as follows:

| Rule | Description |
|---|---|
| 1 | Multi Device Connector Monitor |
| 2 | Compromised Device |
| 3 | A Priori Log Recall |
| 4 | Attacker Identification Scan Correlation |
| 5 | Protocol Verification |
| 6 | Coordination Detection |
| 7 | Splice Detection |
| 8 | TTL penetration depth (augment the Netmap) |
| 9 | IDS Signature Partitioning (setting up |
| | different network intrusion detection system |
| | to watch different system types - correlate |
| | with TowerView) |
| 10 | ViewConnect (new visual for correlating |
| | events |
| NIDS - 4* | Inside/Outside Traffic To Attacking Networks |
| NIDS - 5* | New Destination Ramp |
| NIDS - 9* | HIDS/NIDS Delta Alert on Target |

*Correlation rules from network intrusion detection system Guidelines

Rule 1—Multidevice Connection Monitor (600)

Each network packet, on its way through the system, is processed and/or detected by security devices such as the firewalls, the intrusion detectors and the like. These devices register the packet in the sense that they monitor its information positively.

Once an intrusion event is detected, any packet with similar characteristics can be similarly filtered during the attack. Any of these devices can trigger on the packet with specific IP address of either source or destination, a specific session ID, protocol, Port number, or combination of that data. Effectively, this device does real-time data mining of this information by correlating among the network sniffer parts. The rule operates as follows

Parameters

| Parameter | Description |
|---|---|
| MDCMQUERY | A data structure with containing query |
| | parameters (SRCIP, DESTIP, SESSION, |
| | PROTOCOL, PORT, QUERYID) |
| CONNECTIONCHAIN | The list of FWID, NIDSID, HIDSID that |
| | should register the connection |

IF(OPERATOR REQUESTS THE MULTIDEVICE CONNECTION
SERVICE)

QUERYID++
GET QUERY DATA(POPULATE MDCMQUERY - MUST
CONTAIN SRCIP OR DESTIP)
DETERMINE CONNECTIONCHAIN (TRAVERSE NSM AND
NOD TO DETERMINE DEVICES

THAT SHOULD REGISTER CONNECTION)

DETERMINE DISPLAY(CALCULATE DISPLAY
PRESENTATION BASED ON # OF SECURITY

DEVICES THAT SHOULD REGISTER THE CONNECTION)
IF ATTACK MESSAGE OR CONNECTION MESSAGE
RECEIVED(INCLUDES RAW DEVICE MESSAGES)
FOR EACH DEVICE IN CONNECTIONCHAIN

IF NIDSID OR FWID = REPORTING DEVICE

ACTIVATE ID ON DISPLAY AS REGISTERED
ALARM MDCM CONNECTION REGISTRATION

The connection chain is an important logical grouping of security devices, representing all the security devices through which any packet must pass as it traverses the network to its destination. The path through the network that the packet takes between source and destination represents the vector of approach that is monitored by the security infrastructure.

Correlation of the events needs to consider the connection change in all of its security devices. In order to facilitate the correlation, a connection change is formed as a logical quality of the Network Segment Map (NSM) which contains all connection chains in the network. The list of devices that make up any connection is part of the Network Objects Database 410 (NOD).

Rule 2—Compromised Device (605)

As in the Multi Device Connection Monitor, each security device may register packets as they traverse the network. A security device is a network connector (a Firewall), a network monitor (NIDS) or a network node (HIDS). Assuming a detectable attack and functioning security devices, a packet that is part of the attack may register with each security device through or by which the attack packet passes. If this is not the case, then there is a possibility that one or more of the security devices has been compromised. Compromised in this sense means that the device is not recognizing or alerting on the presence of the attack. A device can be compromised due to both unintentional or intentional misconfiguration. Also, it is possible that the device is off-line or malfunctioning, or that somehow the traffic has been rerouted to avoid the device. In any case, this can signify a security risk.

Parameters

| Parameter | Description |
|---|---|
| CONNECTIONCHAIN | The list of FWID, NIDSID, HIDSID that |
| | should register the connection |
| REGTIMETHRESHOLD | The time period that the registration |
| | from all devices is expected |
| ATTACKINSTANCE | A data structure that identifies the |
| | specific instance of the attack |
| | including ATTACKID and TIMESTAMP. |
| TIMER | A time counter |

IF ATTACK MESSAGE RECEIVED
SET ATTACK_ATTACKINSTANCE (ASSIGN ID TO THIS
ATTACK)
START TIMER
WHILE TIMER <REGTIMETHRESHOLD

FOR EACH DEVICE IN CONNECTIONCHAIN

HAS ATTACK_INSTANCE MESSAGE BEEN
RECEIVED?

FOR EACH DEVICE IN CONNECTIONCHAIN

IF ATTACK_ATTACKINSTANCE MESSAGE NOT
RECEIVED FLAG DEVICE

IF A DEVICE IS FLAGGED ALARM COMPROMISED DEVICE(S)

The ATTACKINSTANCE is a measure of attack messages being registered from multiple devices. This is one underlying assumption or prerequisite of correlation. The creation of an attack instance in this rule is presented for clarity.

The criticality of this alarm is subordinate to the attack itself. The operator will need to determine if the attack was a false positive or an actual attack. If an actual attack is taking place this should be resolved. After that this alarm should be processed to determine how/why the device became compromised. See A Priori Log Recall rule (610).

Rule 3—A Priori Log Recall (610)

If the attack is unknown (not detectable by network intrusion detection system signature) then there is a possibility that either a smart network intrusion detection system (anomalous behavior detection) or a HIDS will detect the attack. The smart network intrusion detection system might detect something different about the packet or session. The HIDS might detect the affect that the attack has on the running processes or the configuration files on the target host. In either case, the smart NIDS, HIDS, or both detect the attack and generate an alarm (or alarms).

An operator may then investigate the event by collecting data from disparate sources, analyzing it and making a determination. This rule facilitates rapid investigation by allowing the operator to quickly access all data relating to the event.

Therefore, this rule does not generate an alarm, but rather creates a framework for accessing the data that is collected by the security infrastructure management system. Other rules generate alarms, and when that happens, the option to launch the log recall of this rule is presented. This log recall correlates among the different alarm information to produce its output.

Parameters

| Parameter | Description |
|---|---|
| CONNECTIONCHAIN | The list of FWID, NIDSID, HIDSID that |
| | should register the connection |
| TIMESTAMP | The time of the attack |
| TIMEWINDOW | An amount of time added and subtracted |
| | from the timestamp to determine the time |
| | window of interest |
| ATTACKINSTANCE | A data structure that identifies the |
| | specific instance of the attack |
| | including ATTACKID and TIMESTAMP. |

IF OPERATOR REQUESTS APLC SERVICE
FOR EACH DEVICE IN CONNECTIONCHAIN

IF DEVICE DID NOT REGISTER THE ATTACKINSTANCE

RETRIEVE LOGS BASE ON TIMEWINDOW AND ATTACK

MESSAGE CONTENTS

ALARM WHEN LOGS ARE AVAILABLE
PRESENT AVAILABLE LOGS GRAPHICALLY

IF OPERATOR SELECTS DEVICE LOG

PRESENT LOG (A FORMAT THAT CAN BE SORTED LIKE
COLUMNS IN EXCEL SPREADSHEET)

Rule 4—View Connect (615)

View Connect correlates connections to and from a designated IP address, providing a graphical presentation of connections between internal and external IP addresses. The operator can specify an internal IP, external IP address or both, and then get a graphical presentation of what connections have been made between them.

View connect uses the raw data collected from Network Sensors, the Detected Attacks Database (DAD) and log aggregation to present all connections for a time period specified by the operator. If the operator specifies the current time as the period start, then View Connect will display connections as they are detected. When the operator specifies a time period from the past, the connection history is deduced from querying stored event logs. When suspicious activity is being investigated the view connect window can be used as a launching point for log and event queries.

Parameters

| Parameter | Description |
|---|---|
| VIEWCONNECTWINDOW | A data structure that defines an |
| | active View Connect window |
| CONNECTION | A data structure for storing |
| | connection information detected |
| | by raw network sensors. Contents |
| | include TIMESTAMP, PORT, |
| | SRCIP, DESTIP, PACKET, |
| | CONTENTS (or pointer to) |
| CONNECTIONLOG | An array or database of |
| | CONNECTIONS |
| DAD | The Detected Attacks Database |
| PERIODSTART | The start of the period (or |
| | current time) |
| PERIODEND | The end of the period (or 0 if |
| | STARTPERIOD = current time) |
| ACTIVEMONITOR | The View Connect is an |
| | active ongoing view (Boolean) |

IF CONNECTION MESSAGE RECEIVED

ADD CONNECTION TO CONNECTIONLOG
IF ACTIVEMONITOR

IF SRCIP OR DESTIP IN VIEWCONNECTWINDOW

UPDATE ACTIVE VIEWCONNECTWINDOW

CONTINUE

IF OPERATOR REQUESTS CV SERVICE

PROMPT FOR PERIODSTART
PROMPT FOR PERIODEND
IF PERIODSTART = CURRENT TIME

ACTIVEMONITOR = TRUE

QUERY CONNECTIONLOG FOR PERIOD
QUERY DAD FOR PERIOD
UPDATE ACTIVE VIEWCONNECTWINDOW

The VIEWCONNECTWINDOW data structure for this rule includes all the data necessary to graphically present the connections that are occurring or that have occurred during the period specified. The data structure has a static record that defines the source and destination IP addresses with a linked list of linked lists that contain the connection information. The primary linked list is indexed by protocol or port number. The secondary linked lists contain the connection information for each individual connection numbers. The network segment map can also be used to form a display depicting the network topology to indicate the different possible connection paths that connections take when wildcarding is used.

View Connect is similar to Multi Device Connection Monitor in that it is a network wide correlating sniffer. View Connect automates the processes that analysts typically perform during an investigation and to extend the concept (ongoing connection view) to real time graphical connection monitoring.

Rule 5—Intrusion Detection System Signature Partitioning (620)

Tower View can be used to manage Intrusion Detection Systems that are deployed on a single segment. Each intrusion detection system can be tasked with a subset of all signatures. One intrusion detection system will be configured to collect all other traffic. This helps coordinate how IDSes are deployed and adds the concept of a raw packet collector that the event stream from IDSes deployed for specific signature detection the overall throughput of the individual IDSes is maximized.

Rule 6—Attacker Identification Scan Correlation (625)

This correlates among the information to actively obtain intelligence about attacks/scans in order to determine if decoy systems/attacks/scans are being deployed by the attacker. Ping, traceroute, nmap and other utilities can be started during or after an attack and the results compared against data extracted from the attack packets.

As each attack is detected, the analyst will know from previous rules the source IP of the attack packet and will have an idea as to whether or not the source IP was spoofed. Sophisticated attackers will want to remain anonymous and therefore will utilize systems belonging to others (attack proxies or zombies—previously compromised systems) to launch attacks at their ultimate target.

Some intrusion detection system systems utilize dynamic rule set creation by scanning all IP addresses that they are allocated to project. The scan determines the operating system version running on all the IP addresses. Once this information is determined with some certainty, packets destined for each IP addresses are only checked for signatures that affect the operating system version running on the destination IP address.

This same approach can be utilized when evaluating the source of detected attacks or anomalous packets. In this context the scan is an Attacker Identification scan (AI Scan). Note that actively scanning remote IP addresses might also identify you as an attacker. AI Scanning can be done by a third party and the results distributed as service (see www.hexillion.com Online Utilities). The AI Scan is executed in real-time or near real time and transmitted back to the customer victim. Subsequently an email is sent to the AI Scan target with the attack packet and AI Scan time as a courtesy. Anyone who detects and shuns the scanning IP address is unlikely to have vulnerable systems.

Several prerequisite or non-hostile (an OS identification scan might be considered hostile) utilities can be executed and evaluated prior to performing or requesting an AI Scan. Nslookup, traceroute and whois can be evaluated concurrently for domain verification. Domains of reputable companies can be treated with more caution. In this context a reputable company is one that can be expected to terminate the attack and eliminate the vulnerability (e.g. IBM, Cisco, Arthur Anderson: ). The domains that generate attacks will be identified with attack probabilities (see network intrusion detection system rule 2 Attack Sequence Sourcing—Source Probability) and networks with poor security will be identified.

Parameters

| Parameter | Description |
|---|---|
| KNOWNATTACKNETS | An array of NETWORKS that |
| | have attacked (see network |
| | intrusion detection system |
| | rule 2) |
| AP | Attack Probability (see |
| | network intrusion detection |
| | system rule 2) |
| KNOWNREPUTABLENETS | An array of NETWORKS |
| | assumed or verified to be |
| | reputable (this list can |
| | start with the list of |
| | companies on the Russell 2000 |
| | stock index that have IP |
| | domains). |
| AISCANTHRESHOLD | A threshold for AP above |
| | which AI scanning is automatic, |
| | otherwise the operator is |
| | prompted to scan |
| VULNERABILITYINDEX | An index of operating system |
| | versions and their known |
| | vulnerabilities. |

IF ATTACK MESSAGE RECEIVED
IF AP OF ATTACKNET IS < AISCANTHRESHOLD

DISPLAY SCAN WARNING TO OPERATOR -
PROMPT FOR CONTINUATION
IF OPERATOR TERMINATES SCAN

EXIT

AI SCAN START(COULD BE LOCAL OR REMOTE THROUGH
THIRD PARTY SERVICE)
TRACEROUTE TO ATTACK_SRCIP
NSLOOKUP ATTACK_SRCIP
WHOIS ATTACK_SRCIP
IF TRACEROUTE AND NSLOOKUP MATCH

IF DOMAIN IN KNOWNREPUTABLENETS

SHUN IP ADDRESS
ALARM ALERT REPUTABLE NETWORK
ADMINISTRATOR
EXIT

NMAP-O ATTACK_SRCIP
IF OS OF ATTACK_SRCIP DETERMINABLE

IF VULNERABILITYINDEX[OS] HAS VULNERABILITIES

ALARM POSSIBLE ZOMBIE OR ATTACK PROXY
RETURN AI SCAN INFORMATION
EXIT

ALARM VULNERABILITY OF SOURCE INDETERMINABLE
RETURN AI SCAN INFORMATION
AI SCAN END

Rule 7—Protocol Verification (630)

This rule determines if data from a raw intrusion detection system intercepted packet contains the correct protocol. Protocol disguising is a technique that utilizes standard ports to obscure otherwise convert channels. This rule requires that packets be analyzed at higher layers in the TCP/IP five layer model. As each successive higher layer is analyzed, the performance of the verification logic is reduced. This rule contemplates using special purpose raw IDSes are deployed for this purpose (see intrusion detection system Signature Partitioning method).

Parameters

| Parameter | Description |
|---|---|
| PROTOCOLSIGSEQUENCE | A sequence of identifiable elements in |
| | a packet stream that identify or |
| | disqualify the stream as a well known |
| | protocol |

IF A CONNECTION MESSAGE RECEIVED
START PROTOCOL VERIFICATION ON SEQUENCE
IF PACKET STREAM IS IDENTIFIED

EXIT

ALARM IMPROPER PROTOCOL CONSTRUCT

Note on PROTOCOLSIGSEQUENCE

The logic for protocol identification uses the first packets in the connection to create deterministic qualities that can be compared against a protocol session grammar.

Rule 8—Coordination Detection (635)

This rule alerts when different sources are coordinating on attacks. By analyzing the detected attacks database, it becomes possible to group the source NETWORKS of attacks based on how they repeat or fail to repeat attacks. This information enables assigning a probability to a group of IP addresses that analyzes how attacks are dispersed.

The most sophisticated attackers will attack less frequently than script kiddies. Therefore the frequency and timing of attacks is also critical to this rule. This rule will only analyze attacks from attacking NETWORKS that are in the lowest percentile in frequency. Note that from this point of view, this rule is quite counterintuitive, since it places the highest priority on the items which create the fewest attempts at intrusion.

The Attack Sequence Sourcing—Source Probability rule in the network intrusion detection system guidelines deals with quantitative elements of sequences of attacks in order to identify networks that are prone to launching attacks.

Coordination Detection examines sequences of attacks using the following quantitative criteria:

Is an attack or probe launched once or at a low frequency from a NETWORK

Does a sequence of attacks from different networks constitute set of unique set of attacks

Can the order of attacks be considered logical in that probes for a vulnerability come from one NETWORK and exploit attempts come from another NETWORK in that order.

Parameters

| Parameter | Description |
|---|---|
| APTHRESHOLD | The value of Attack Probability |
| | that qualifies an attack source |
| | for processing |
| ATTACKCOUNTTHRESHOLD | The number of attacks below |
| | which processing will execute |
| NETWORK | Origin Class C network of the |
| | SRCIP Address AND |
| | (SRCIP,ff.ff.ff.0) See |
| | network intrusion detection |
| | system Rule 2 |
| KNOWNATTACKNETS | An array of NETWORKS that have |
| | attacked. See network intrusion |
| | detection system Rule 2 |
| ATTACKTOTAL | An aggregate total of all |
| | attacks. See network |
| | intrusion detection system |
| | Rule 2 |

RUN COORDINATION DETECTION PERIODICALLY(HOURLY)
BEGIN COORDINATION DETECTION BLOCK
FOR EACH NETWORK IN KNOWATTACKNETS

IF NETWORK_ATTACKTOTAL
<ATTACKCOUNTTHRESHOLD

OPTIONAL - SORT ATTACK_NAME BY

SORT ATTACK_NAME BY PORT

TARGET SORT ATTACK_NAME

BY ATTACKTIME
END COORDINATION DETECTION BLOCK
IF OPERATOR REQUESTS CD SERVICE

DISPLAY SORTED LIST OF ATTACK_NAMES

The Coordination Detection display shows a sorted list of attacks from low frequency attacking networks sorted by TARGET, PORT and Time. This enables the operator to view activity from different networks prior to the attack. The option to display CD services should be on all new attacks (defined by INCEPT), anomalous behavior alerts from smart network intrusion detection system and on protocol verification failures.

Rule 9—Splice Detection (640)

This rule alerts when multiple packets in a stream have much less than “average” payload. By setting thresholds based on averages calculated from the FW and intrusion detection system systems the system can alert when streams of packets deviate significantly on the low side, indicating the possibility of a splicing attack sequences. Splicing attacks allow attackers to slip past IDSes because the number of data structures required to maintain the state is too high.

Parameters

| Parameter | Description |
|---|---|
| PROTOCOLPACKETSIZE | This factor is the average packet |
| | payload size for a protocol |
| PACKETPAYLOADSIZE | The size of the packet payload |
| SPLICETHRESHOLD | The negative factor that when |
| | added to the packet payload |
| | size constitutes a possible splice |
| WINDOWPACKETCOUNT | A counter to track the number |
| | of packets in a window |
| WINDOWPAYLOAD | The sum of packet payload |
| | sizes for the window |
| WINDOWAVEPAYLOAD | The average payload for |
| | the packets in the window |
| COUNTTHRESHOLD | The number of packets to |
| | check before exiting |

IF CONNECTION MESSAGE RECEIVED
FOR EACH PACKET CALCULATE PROTOCOLPACKETSIZE
(A RUNNING AVERAGE)
START SPLICE DETECTION
WINDOWPACKETCOUNT=1
WINDOWPAYLOAD=0
FOR EACH PACKET IN THE CONNECTION

IF WINDOWPACKETCOUNT > COUNTTHRESHOLD

WINDOWWAVEPAYLOAD=WINDOWPAYLOAD/
WINDOWPACKETCOUNT

IF WINDOWAVEPAYLOAD<(PROTOCOLPACKETSIZE -
SPLICETHRESHOLD)

ALARM CONNECTION SPLICING IN PROGRESS

WINDOWPAYLOAD= WINDOWPAYLOAD +
PACKETPAYLOADSIZE
WINDOWPACKETCOUNT++

END SPLICE DETECTION

Each protocol relies on a sample network average calculated for comparison purposes. After a connection starts, the average packet payload of a window of packets is also calculated and compared to the protocol average. If the window average is significantly lower than the protocol average, an alarm is generated. It should be noted that some protocols have naturally low payloads (e.g. telnet). Text based interactive protocols such as telnet tend to send one character per packet as payload. Low payload protocols will not be checked for splicing. Splice detection is a simple anomalous behavior alarm.

Rule 10—TTL Penetration Monitor (645)

This rule will alert when the TTL field is lower than the expected TTL to reach the destination in the network. A new field in the Network Objects Database Structure will be used to store TTL values for all network objects for comparison.

Parameters

| Parameter | Description |
|---|---|
| NODTTL | The number of routers traffic must pass |
| | through to exit the network from the host |
| DESTIP | The destination IP address for the packet |
| SRCIP | The source IP address for the packet |

IF PACKET, CONNECTION OR ATTACK MESSAGE RECEIVED

IF SRCIP IS INTERNAL

IF TTL IN PACKET < NODTTL_SRCIP

ALARM LOW TTL IN PACKET INTERNAL

ELSE

IF TTL IN PACKET < NODTTL_DESTIP

ALARM LOW TTL IN PACKET EXTERNAL

The above has described a detailed rule set for use in a computer system. The rule set may be carried out by executing on a network server such as 130, or within a firewall. Alternatively, the rules set can be carried out entirely in software, or alternatively entirely within hardware. It should be understood that the techniques described herein are applicable to a hardware device, such as an appliance, which carries out an integrated combination of all of these rule sets and their combinations. Accordingly, all such modifications are intended to be encompassed within the following claims.

What is claimed is:

1. A network monitoring system, comprising:
a rules server, running a plurality of separate rules which monitor aspects of a network, including at least a first rule that monitors operations of the network to produce a first alarm representing a first specified probability of attack on the network, based on a first network condition other than content of packets of information being processed by the network, and a second rule that detects content of network packets being processed by the network, to produce a second alarm representing a second specified probability of attack on the network, based on suspicious content in said network packets, and a third rule that correlates results of said first and second rules, to produce information indicative of a correlated probability of attack on the network that represents a higher probability than a probability represented by either said first alarm or said second alarm.

2. A system as in claim 1, wherein said first rule comprises monitoring a condition of a firewall within the network.

3. A system as in claim 2, wherein said first rule includes a rule that monitors a way in which the firewall is being administered.

4. A system as in claim 1, wherein said second rule comprises detecting trends within said network packet content.

5. A system as in claim 4, wherein said second rule comprises monitoring requests from specified network addresses, identifying requests which include attempted network intrusions, and maintaining an attack probability for a first specified network address by increasing said attack probability based on identifying said requests from said first specified network address which include an attempted network intrusion.

6. A system as in claim 5, further comprising decreasing said attack probability after a specified amount of time of not receiving a request which includes an attempted network intrusion from said first specified network address.

7. A system as in claim 3, wherein said first rule includes a rule which defines a length of time since specified servicing of the firewall.

8. A system as in claim 4, wherein said detecting trends comprises detecting a trend in increase or decrease of a number of rejected network packets.

9. A system as in claim 1, wherein said second rule comprises determinining information indicative of a slope of a curve which plots amounts of suspicious content against time, and determines a probability of attack based on said slope of said curve.

10. A system as in claim 9, further comprising producing an alarm of a specified criticality for a linear slope, and producing a second alarm of a higher criticality for a slope which is greater than linear.

11. A system as in claim 1, wherein said second rule provides weighting for specified events.

12. A system as in claim 11, wherein said second rule provides a higher weighting for an event which happens less often.

13. A system as in claim 1, wherein said second rule monitors a trend of data, and detects a change in the trend to signal an alarm.

14. A system as in claim 13, wherein said second rule monitors an average density of network packets, and said trend comprises a reduction in data density within the network packets.

15. A system as in claim 13, wherein said second rule monitors sources from failed networks attacks and maintains a probability of attack from said sources.

16. A system as in claim 1, wherein said third rule monitors multiple clients detecting similar parameters, and detects whether each of the multiple clients have each detected a similar change in said similar parameters, and increases a criticality of an alarm based on detecting that each of the multiple clients have each detected the similar change.

17. A system, comprising:
a network monitoring system which monitors network traffic; and
a rules server including a first set of rules detecting alarms based on a network firewall, a second set of rules detecting alarms based on network intrusion detection events, and a third set of rules detecting alarms based on authentication events, each detection of each alarm having a criticality, and a fourth set of rules correlating at least one of said rules with another of said rules to produce an alarm that has a higher criticality than that produced by either of said one rule or said another rule individually.

18. A system as in claim 17, wherein at least one of said sets of rules includes a probabilistic based rule that detects a probability of network attack based on an event that is not actually a successful network attack.

19. A system as in claim 18, wherein said probability of network attack is detected from an unsuccessful network attack.

20. A system as in claim 18, further comprising maintaining a probability count for a specified network address by increasing a count for the network address when conditions indicative of an attack are detected, and decreasing the count for the network address when no conditions indicative of attack are detected for a specified time.

21. A system as in claim 18, wherein said probability of attack is determined by monitoring a trend of network events.

22. A system as in claim 17, wherein said third set of rules includes a host-based intrusion system rule set, and wherein said fourth set of rules includes a rule that correlates an alarm generated by said host-based intrusion set with a corresponding alarm based on said network intrusion detection rules and increases a criticality of an alarm produced when both said alarm is generated by said host-based intrusion set and said corresponding alarm is produced based on said network intrusion detection rules, compared to an alarm that would be produced for either of said host-based intrusion set or said corresponding alarm, individually.

23. A system as in claim 17, wherein said third set of rules includes rules detecting a virtual private network intrusion.

24. A system as in claim 23, wherein said third set of rules establishes an alarm based on virtual private network key exchanges of more than a specified amount.

25. A system as in claim 17, wherein said first set of rules monitors characteristics of a firewall firewall monitoring system.

26. A system as in claim 17, wherein said first set of rules monitors a trend of otherwise acceptable events, and establishes an alarm based on the trend being greater than a specified amount.

27. A system comprising:
a network monitoring system that monitors network traffic; and
a rules server, including a set of firewall rules, a set of network intrusion detection rules, and a set of authentication rules, and a set of correlating rules which correlates at least one of said rules with another of said rules, at least one of said correlating rules detecting first and second alarms from violations of rules, said first and second alarms each having a specified criticality, and using the correlating to increase a criticality of an alarm from violating the combination of rules as compared with violating either of the rules individually.

28. A system as in claim 27, wherein said at least one rule comprises a rule looking for similar suspicious activity on multiple devices from the same network address.

29. A system as in claim 27, wherein said at least one rule monitors a trend in specified activity.

30. A system as in claim 27, wherein said at least one rule monitors for unusual numbers of packets of a specified protocol.

31. A system as in claim 27, wherein said at least one rule monitors for trends in numbers of denied packets per unit time.

32. A system as in claim 27, wherein at least one of said rules monitors based on precompiled information about an architecture of a network.

33. A system as in claim 28, wherein said correlating rules correlates a suspected attack against a network based intrusions system, with a similar suspected attack against a host-based intrusions system.

34. A system as in claim 27, wherein said correlating rules correlating scans of a network from a first network address at a first time with later packets being sent from said first network address at a later time.

35. A method of monitoring a network, comprising:
running a first rule that monitors operations of a first part of the network to produce a first alarm based on a first network condition, said first alarm having a first criticality;
running a second rule that detects operations of a second part of the network, to produce a second alarm based on suspicious content in said second part of said network, said second alarm having a second criticality; and
running a third rule that correlates the first and second alarms produced by said first and second rules, to produce correlation alarm information that represents a higher criticality than a criticality of either said first alarm or said second alarm.

36. A method as in claim 35, wherein said first rule comprises monitoring of conditions of a firewall within the network.

37. A method as in claim 36, wherein said running a first rule comprises monitoring a way in which the firewall is being administered.

38. A method as in claim 35, wherein said running a second rule comprises detecting trends contents of network packets.

39. A method as in claim 38, wherein said running a second rule comprises monitoring requests from specified network addresses, identifying requests which include attempted network intrusions, and maintaining an attack probability for a first specified network address and increasing said attack probability based on identifying said requests from said first specified network address which include an attempted network intrusion.

40. A method as in claim 39, further comprising decreasing said attack probability after a specified amount of time of not receiving a request which includes an attempted network intrusion from said first specified network address.

41. A method as in claim 38, wherein said detecting trends comprises detecting a trend in increase or decrease of a number of rejected network packets.

42. A method as in claim 35, wherein said second rule comprises determinining information indicative of a slope of a curve which plots amounts of suspicious content against time, and determining a probability of attack based on said slope of said curve.

43. A method as in claim 42, further comprising producing a first alarm of a specified criticality for a linear slope, and producing a second alarm of a higher criticality for a slope which is greater than linear.

44. A method as in claim 35, wherein said first rule comprises a firewall rule; said second rule comprises a network intrusion detection rule, and further comprising a third rule which is a network authentication rule.
